(19) United States
(12) Patent Application Publication
(10) Pub. No.: US 2026/0311640 A1
(43) Pub. Date: Oct. 8, 2026

(54) PIXEL CIRCUIT, PIXEL DRIVING METHOD AND DISPLAY APPARATUS

(71) Applicant: BOE TECHNOLOGY GROUP CO., LTD., Beijing (CN)

(72) Inventors: Lujiang Huangfu, Beijing (CN); Tuo Sun, Beijing (CN); Jianchao Zhu, Beijing (CN)

(73) Assignee: BOE TECHNOLOGY GROUP CO., LTD., Beijing (CN)

(21) Appl. No.: 18/996,641

(22) PCT Filed: Nov. 9, 2023
(86) PCT No.: PCT/CN2023/130646

§ 371 Date: Jan. 17, 2025

(30) Foreign Application Priority Data
Dec. 26, 2022 (CN) 202211678304.4

(51) Int. Cl. G09G 3/3233

(52) U.S. Cl. CPC G09G 3/3233; G09G 2300/0852; G09G 2310/08; G09G 2320/0233

(57) ABSTRACT

A pixel circuit, a pixel driving method, and a display apparatus are provided. Pixel circuit includes light-emitting element, driving circuit, first energy storage circuit, second energy storage circuit, switch control circuit, data writing circuit. Data writing circuit writes data voltage into second node under control of a signal. First end of first energy storage circuit is electrically connected to second node, second end of first energy storage circuit is electrically connected to first node. Under control of a signal, switch control circuit controls whether first node is connected to the first voltage terminal through second energy storage circuit. Second energy storage circuit is for storing electric energy.

### CROSS-REFERENCE TO RELATED APPLICATION

This application is a U.S. national application of PCT application No. PCT/CN2023/130646 filed on Nov. 9, 2023, which claims priority to Chinese Patent Application No. 202211678304.4 filed in China on Dec. 26, 2022, the disclosure of which is hereby incorporated by reference in its entirety.

### TECHNICAL FIELD

The present disclosure relates to the field of display technologies, and in particular, to a pixel circuit, a pixel driving method, and a display device.

### BACKGROUND

In the related art, a data voltage provided by the Driver Integrated Circuit (DrICs) of a display signal needs to ensure that under a certain pixel circuit design, a display brightness dynamic range needs to be sufficiently large for indoor and outdoor environments of different brightness levels. Due to technical limitations such as DrICs output precision at a present stage, a minimum output variation amplitude of the DrICs generally cannot meet the requirement of a sufficiently small grayscale brightness difference required for displaying a low brightness level in a darkroom environment.

### SUMMARY

In a first aspect, a pixel circuit is provided. The pixel circuit includes: a light-emitting element, a driving circuit, a first energy storage circuit, a second energy storage circuit, a switch control circuit, and a data writing circuit; wherein a control terminal of the driving circuit is electrically connected to a first node, a first terminal of the driving circuit is electrically connected to a power supply voltage terminal, a second terminal of the driving circuit is electrically connected to the light-emitting element, and the driving circuit is configured to drive the light-emitting element under control of a potential at a control terminal of the driving circuit; the data writing circuit is electrically connected to a write control terminal, a data line, and a second node, respectively, and is configured to write a data voltage, provided by the data line, to the second node under a control of a write control signal provided by the write control terminal; a first end of the first energy storage circuit is electrically connected to the second node, a second end of the first energy storage circuit is electrically connected to the first node, and the first energy storage circuit is configured to store electric energy; the switch control circuit is electrically connected to a switch control terminal, the second energy storage circuit, and a first voltage terminal, respectively, and is configured to control, under control of a switch control signal provided by the switch control terminal, whether the first node is electrically connected to the first voltage terminal through the second energy storage circuit; and the second energy storage circuit is configured to store electric energy.

Optionally, a control terminal of the switch control circuit is electrically connected to the switch control terminal, a first terminal of the switch control circuit is electrically connected to the first node, a second terminal of the switch control circuit is electrically connected to a first end of the second energy storage circuit, and the switch control circuit is configured to control, under control of the switch control signal, the first node to be connected to or disconnected from the first end of the second energy storage circuit; a second end of the second energy storage circuit is electrically connected to the first voltage terminal.

Optionally, a first end of the second energy storage circuit is electrically connected to the first node; a control terminal of the switch control circuit is electrically connected to the switch control terminal, a first terminal of the switch control circuit is electrically connected to a second end of the second energy storage circuit, a second terminal of the switch control circuit is electrically connected to the first voltage terminal, and the switch control circuit is configured to control the second end of the second energy storage circuit to be connected to or disconnected from the first voltage terminal under control of the switch control signal.

Optionally, the switch control circuit further includes a third terminal; a third terminal of the switch control circuit is electrically connected to the second node, and the switch control circuit is further configured to control, under control of the switch control signal, the second node to be connected to or disconnected from the second end of the second energy storage circuit.

Optionally, the pixel circuit in at least one embodiment of the present application further includes: a third energy storage circuit, wherein a first end of the third energy storage circuit is electrically connected to the first node, a second end of the third energy storage circuit is electrically connected to the first voltage terminal, and the third energy storage circuit is configured to store electric energy.

Optionally, the pixel circuit in at least one embodiment of the present application further includes: a third energy storage circuit, wherein a first end of the third energy storage circuit is electrically connected to the first node, a second end of the third energy storage circuit is electrically connected to the first voltage terminal, and the third energy storage circuit is configured to store electric energy.

Optionally, the switch control circuit includes a switching element, the first energy storage circuit includes a first capacitor, and the second energy storage circuit includes a second capacitor; a control terminal of the switching element is electrically connected to the switch control terminal, a first terminal of the switching element is electrically connected to the first node, and a second end of the second capacitor is electrically connected to a first end of the second capacitor; and the switching element is configured to control, under control of the switch control signal, the first terminal of the switching element to be connected to or disconnected from the second end of the second capacitor; a first end of the first capacitor is electrically connected to the second node, and a second end of the first capacitor is electrically connected to the first node; a second end of the second capacitor is electrically connected to the first voltage terminal.

Optionally, the switch control circuit includes a switching element, the first energy storage circuit includes a first capacitor, and the second energy storage circuit includes a second capacitor; a control terminal of the switching element is electrically connected to the switching control terminal, a first terminal of the switching element is electrically connected to a second end of the second capacitor, and a second terminal of the switching element is electrically connected to the first voltage terminal; and the switching element is configured to control, under control of the switching control signal, the first terminal of the switching element to be connected to or disconnected from the second terminal of the switching element; a first end of the first capacitor is electrically connected to the second node, and a second end of the first capacitor is electrically connected to the first node; a first end of the second capacitor is electrically connected to the first node.

Optionally, the switch control circuit includes a double-throw switch element; the first energy storage circuit includes a first capacitor, and the second energy storage circuit includes a second capacitor; a first end of the first capacitor is electrically connected to the second node, and a second end of the first capacitor is electrically connected to the first node; a first end of the second capacitor is electrically connected to the first node; a control terminal of the double-throw switch element is electrically connected to a switch control terminal, a first terminal of the double-throw switch element is electrically connected to a second end of the second capacitor, a second terminal of the double-throw switch element is electrically connected to the first voltage terminal, and a third terminal of the double-throw switch element is electrically connected to the second node; the double-throw switch element is configured to control the first terminal of the double-throw switch element to communicate with the second terminal of the double-throw switch element or the third terminal of the double-throw switch element under control of the switch control signal.

Optionally, the third energy storage circuit includes a third capacitor; a first end of the third capacitor is electrically connected to the first node, and a second end of the third capacitor is electrically connected to the first voltage terminal.

Optionally, the pixel circuit in at least one embodiment of the present disclosure further includes: a first initialization circuit, a second initialization circuit, a voltage control circuit, a compensation control circuit, and a light-emitting control circuit; wherein the first initialization circuit is electrically connected to an initial control terminal, a reference voltage terminal, and the second node, respectively, and is configured to control the reference voltage terminal to provide a reference voltage to the second node under control of an initial control signal provided by the initial control terminal; the second initialization circuit is electrically connected to the initial control terminal, the initial voltage terminal, and the first node, respectively, and is configured to control the initial voltage terminal to provide an initial voltage to the first node under control of the initial control signal; the voltage control circuit is electrically connected to the light-emitting control terminal, the reference voltage terminal, and the second node, and is configured to control the reference voltage terminal to provide a reference voltage to the second node under control of a light-emitting control signal provided by the light-emitting control terminal; the compensation control circuit is electrically connected to the compensation control terminal, the first node, and a second terminal of the driving circuit, and is configured to control the first node to be connected to or disconnected from the second terminal of the driving circuit under control of a compensation control signal provided by the compensation control terminal; the light-emitting control circuit is electrically connected to the light-emitting control terminal, a second terminal of the driving circuit, and a first electrode of the light-emitting element, and configured to control, under control of the light-emitting control signal, the second terminal of the driving circuit to be connected to or disconnected from the first electrode of the light-emitting element; a second electrode of the light-emitting element is electrically connected to the second voltage terminal.

Optionally, the compensation control terminal and the write control terminal are the same control terminal; the driving circuit includes a driving transistor, the data writing circuit includes a first transistor, the compensation control circuit includes a second transistor, the first initialization circuit includes a third transistor, the second initialization circuit includes a fourth transistor, the voltage control circuit includes a fifth transistor, the light-emitting control circuit includes a sixth transistor, and the light-emitting element is an organic light-emitting diode; a gate electrode of the driving transistor is electrically connected to the first node, and a first electrode of the driving transistor is electrically connected to the power supply voltage terminal; a gate electrode of the first transistor is electrically connected to the write control terminal, a first electrode of the first transistor is electrically connected to a data line, and a second electrode of the first transistor is electrically connected to a second node; a gate electrode of the second transistor is electrically connected to the write control terminal, a first electrode of the second transistor is electrically connected to the first node, and a second electrode of the second transistor is electrically connected to a second electrode of the driving transistor; a gate electrode of the third transistor is electrically connected to the initial control terminal, a first electrode of the third transistor is electrically connected to the second node, and a second electrode of the third transistor is electrically connected to a reference voltage terminal; a gate electrode of the fourth transistor is electrically connected to the initial control terminal, a first electrode of the fourth transistor is electrically connected to the first node, and a second electrode of the fourth transistor is electrically connected to the initial voltage terminal; a gate electrode of the fifth transistor is electrically connected to the light-emitting control terminal, a first electrode of the fifth transistor is electrically connected to the second node, and a second electrode of the fifth transistor is electrically connected to the reference voltage terminal; a gate electrode of the sixth transistor is electrically connected to the light-emitting control terminal, a first electrode of the sixth transistor is electrically connected to a second electrode of the driving transistor, and a second electrode of the sixth transistor is electrically connected to an anode of the organic light-emitting diode; a cathode of the organic light-emitting diode is electrically connected to a second voltage terminal.

Optionally, the pixel circuit in at least one embodiment of the present disclosure further includes: a first initialization circuit, a second initialization circuit, a compensation control circuit, and a light-emitting control circuit; the first initialization circuit is electrically connected to a first initial control terminal, a reference voltage terminal, and the second node, and is configured to control the reference voltage terminal to provide a reference voltage to the second node under control of a first initial control signal provided by the first initial control terminal; the second initialization circuit is electrically connected to the second initial control terminal, the initial voltage terminal, and the first node, and is configured to control the initial voltage terminal to provide an initial voltage to the first node under control of a second initial control signal provided by the second initial control terminal; the compensation control circuit is electrically connected to the compensation control terminal, the first node, and the second terminal of the driving circuit, and is configured to control the first node to be connected to or disconnected from the second terminal of the driving circuit under control of the compensation control signal provided by the compensation control terminal; the light-emitting control circuit is electrically connected to a light-emitting control terminal, a second terminal of the driving circuit, and a first electrode of the light-emitting element, and configured to control, under control of the light-emitting control signal, the second terminal of the driving circuit to be connected to or disconnected from the first electrode of the light-emitting element; a second electrode of the light-emitting element is electrically connected to the second voltage terminal.

Optionally, the compensation control terminal and the first initial control terminal are the same control terminal; the driving circuit includes a driving transistor, the data writing circuit includes a first transistor, the compensation control circuit includes a second transistor, the first initialization circuit includes a third transistor, the second initialization circuit includes a fourth transistor, and the light-emitting control circuit includes a sixth transistor; the light-emitting element is an organic light-emitting diode; a gate electrode of the driving transistor is electrically connected to the first node, and a first electrode of the driving transistor is electrically connected to the power supply voltage terminal; a gate electrode of the first transistor is electrically connected to the write control terminal, a first electrode of the first transistor is electrically connected to a data line, and a second electrode of the first transistor is electrically connected to a second node; a gate electrode of the second transistor is electrically connected to the first initial control terminal, a first electrode of the second transistor is electrically connected to the first node, and a second electrode of the second transistor is electrically connected to a second electrode of the driving transistor; a gate electrode of the third transistor is electrically connected to the first initial control terminal, a first electrode of the third transistor is electrically connected to the second node, and a second electrode of the third transistor is electrically connected to a reference voltage terminal; a gate electrode of the fourth transistor is electrically connected to the second initial control terminal, a first electrode of the fourth transistor is electrically connected to the first node, and a second electrode of the fourth transistor is electrically connected to an initial voltage terminal; a gate electrode of the sixth transistor is electrically connected to the light-emitting control terminal, a first electrode of the sixth transistor is electrically connected to a second electrode of the driving transistor, and a second electrode of the sixth transistor is electrically connected to an anode of the organic light-emitting diode; a cathode of the organic light-emitting diode is electrically connected to a second voltage terminal.

In a second aspect, a pixel driving method is provided, the method is applied to the pixel circuit provided above, the pixel driving method includes: driving, by the driving circuit, the light-emitting element under control of the potential of the control terminal of the driving circuit; writing the data voltage provided by the data line into the second node under control of a write control signal, by the data writing circuit; wherein, the first energy storage circuit stores electric energy, and the second energy storage circuit stores electric energy; controlling, by the switch control circuit under control of the switch control signal, whether the first node is electrically connected to the first voltage terminal through the second energy storage circuit.

Optionally, the step of controlling, by the switch control circuit, whether the first node is connected to the first voltage terminal through the second energy storage circuit under control of the switch control signal includes: in a first display mode, controlling, by the switch control circuit, the first node not to be electrically connected to the first voltage terminal through the second energy storage circuit under control of the switch control signal; in a second display mode, controlling, by the switch control circuit, the first node to be electrically connected to the first voltage terminal through the second energy storage circuit under control of the switch control signal.

In a third aspect, a display device is provided. The device includes the pixel circuit provided above.

### BRIEF DESCRIPTION OF THE DRAWINGS

FIG. 1 is a structural diagram of a pixel circuit according to at least one embodiment of the present disclosure;

FIG. 2 is a structural diagram of a pixel circuit according to at least one embodiment of the present disclosure;

FIG. 3 is a circuit diagram of a pixel circuit according to at least one embodiment of the present disclosure;

FIG. 4 is a circuit diagram of at least one embodiment of the pixel circuit shown in FIG. 3;

FIG. 5 is a circuit diagram of a pixel circuit according to at least one embodiment of the present disclosure;

FIG. 6 is a circuit diagram of a pixel circuit according to at least one embodiment of the present disclosure;

FIG. 7 is a structural diagram of a pixel circuit according to at least one embodiment of the present disclosure;

FIG. 8 is a circuit diagram of a pixel circuit according to at least one embodiment of the present disclosure;

FIG. 9 is a circuit diagram of at least one embodiment of a double-throw switch element;

FIG. 10 is a circuit diagram of a pixel circuit according to at least one embodiment of the present disclosure;

FIG. 11 is a circuit diagram of at least one embodiment of a double-throw switch element;

FIG. 12 is a structural diagram of a pixel circuit according to at least one embodiment of the present disclosure;

FIG. 13 is a structural diagram of a pixel circuit according to at least one embodiment of the present disclosure;

FIG. 14 is a circuit diagram of a pixel circuit according to at least one embodiment of the present disclosure;

FIG. 15 is a circuit diagram of a pixel circuit according to at least one embodiment of the present disclosure;

FIG. 16 is a circuit diagram of a pixel circuit according to at least one embodiment of the present disclosure;

FIG. 17 is a circuit diagram of a pixel circuit according to at least one embodiment of the present disclosure;

FIG. 18 is a circuit diagram of a pixel circuit according to at least one embodiment of the present disclosure;

FIG. 19 is a working timing diagram of at least one embodiment of the pixel circuit shown in FIG. 18 of the present disclosure;

FIG. 20 is a circuit diagram of a pixel circuit according to at least one embodiment of the present disclosure;

FIG. 21 is a structural diagram of a pixel circuit according to at least one embodiment of the present disclosure;

FIG. 22 is a circuit diagram of a pixel circuit according to at least one embodiment of the present disclosure.

### DETAILED DESCRIPTION

The technical solutions in the embodiments of the present disclosure will be clearly and completely described below with reference to the accompanying drawings in the embodiments of the present disclosure. All other embodiments obtained by a person of ordinary skill in the art based on the embodiments of the present disclosure without creative efforts shall fall within the protection scope of the present disclosure.

The main objective of the present disclosure is to provide a pixel circuit, a pixel driving method and a display device, which solve the problem that the minimum output variation amplitude of a driving integrated circuit of a display signal in the related art generally cannot meet the requirement of a sufficiently small grayscale brightness difference required for displaying a low brightness level in a darkroom environment.

The transistors used in all embodiments of the present disclosure may be thin film transistors or field effect transistors or other devices with the same characteristics. In the embodiments of the present disclosure, in order to distinguish two electrodes other than the gate electrode of the transistor, one of the two electrodes is referred to as a first electrode, and the other electrode is referred to as a second electrode.

In an actual operation, when the transistor is a thin film transistor or a field effect transistor, the first electrode may be a drain electrode, and the second electrode may be a source electrode; or the first electrode may be a source electrode, and the second electrode may be a drain electrode.

The pixel circuit according to an embodiment of the present disclosure includes a light-emitting element, a driving circuit, a first energy storage circuit, a second energy storage circuit, a switch control circuit, and a data writing circuit; a control terminal of the driving circuit is electrically connected to a first node, a first terminal of the driving circuit is electrically connected to a power supply voltage terminal, a second terminal of the driving circuit is electrically connected to a light-emitting element, and the driving circuit is configured to drive the light-emitting element under control of a potential at a control terminal of the driving circuit; the data writing circuit is electrically connected to the write control terminal, the data line, and the second node, respectively, and is configured to write a data voltage, provided by the data line, to the second node under control of a write control signal provided by the write control terminal; and a first end of the first energy storage circuit is electrically connected to the second node, a second end of the first energy storage circuit is electrically connected to the first node, and the first energy storage circuit is configured to store electric energy; and the switch control circuit is electrically connected to the switch control terminal, the second energy storage circuit, and the first voltage terminal, respectively, and is configured to control, under control of the switch control signal provided by the switch control terminal, whether the first node is electrically connected to the first voltage terminal through the second energy storage circuit; and the second energy storage circuit is configured to store electric energy.

The pixel circuit according to the embodiments of the present disclosure may perform voltage division transformation on the data voltage by using a capacitor circuit with a controllable voltage division ratio (the capacitor circuit with a controllable voltage division ratio may include a switch control circuit, a first energy storage circuit, and a second energy storage circuit), so as to realize a driving control with smaller grayscale difference in a low brightness display mode while ensuring driving control with a large brightness dynamic range in a high brightness mode.

The embodiments of the present disclosure propose a signal coupling circuit, a voltage division circuit, and a holding capacitor circuit with a controllable voltage division ratio, and after the circuits are embedded into the pixel circuit, the minimum change amplitude and the maximum dynamic amplitude of the data voltage can be realized through mode control, which are respectively adapted to display in a low and high brightness mode.

In the embodiments of the present disclosure, different display modes of a minimum grayscale difference and a brightness dynamic amplitude may be displayed by one pixel circuit by using a capacitor circuit with a controllable voltage division ratio, to respectively adapt to high-brightness mode display and low-brightness mode display.

In at least one embodiment of the present disclosure, a control terminal of the switch control circuit is electrically connected to a switch control terminal, a first terminal of the switch control circuit is electrically connected to a first node, a second terminal of the switch control circuit is electrically connected to a first end of the second energy storage circuit, and the switch control circuit is configured to control, under control of the switch control signal, the first node to be connected to or disconnected from a first end of the second energy storage circuit; a second end of the second energy storage circuit is electrically connected to the first voltage terminal.

Optionally, the switch control circuit includes a switching element; the first energy storage circuit includes a first capacitor, and the second energy storage circuit includes a second capacitor; a control terminal of the switching element is electrically connected to the switch control terminal, a first terminal of the switching element is electrically connected to the first node, and a second end of the second capacitor is electrically connected to a first end of the second capacitor; and the switching element is configured to control, under control of the switch control signal, the first terminal of the switching element to be connected to or disconnected from the second end of the second capacitor; a first end of the first capacitor is electrically connected to the second node, and a second end of the first capacitor is electrically connected to the first node; a second end of the second capacitor is electrically connected to the first voltage terminal.

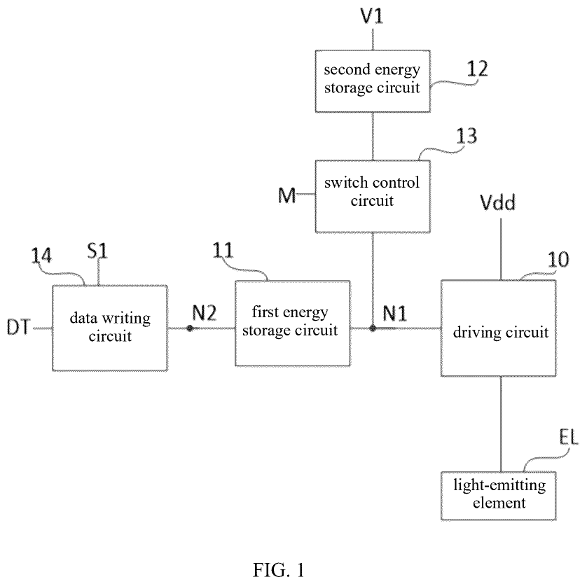

As shown in FIG. 1, the pixel circuit according to at least one embodiment of the present disclosure includes a light-emitting element EL, a driving circuit 10, a first energy storage circuit 11, a second energy storage circuit 12, a switch control circuit 13, and a data writing circuit 14; a control terminal of the driving circuit 10 is electrically connected to the first node N1, a first terminal of the driving circuit 10 is electrically connected to the power supply voltage terminal Vdd, a second terminal of the driving circuit 10 is electrically connected to the light-emitting element EL, and the driving circuit 10 is configured to drive the light-emitting element EL under control of the potential of the control terminal of the driving circuit 10; the data writing circuit 14 is electrically connected to the write control terminal S1, the data line DT, and the second node N2, respectively, and is configured to write the data voltage Vdt provided by the data line DT into the second node N2 under control of the write control signal provided by the write control terminal S1; a first end of the first energy storage circuit 11 is electrically connected to the second node N2, a second end of the first energy storage circuit 11 is electrically connected to the first node N1, and the first energy storage circuit 11 is configured to store electric energy.

A control terminal of the switch control circuit 13 is electrically connected to the switch control terminal M, a first terminal of the switch control circuit 13 is electrically connected to the first node N1, a second terminal of the switch control circuit 13 is electrically connected to a first end of the second energy storage circuit 12, and the switch control circuit 13 is configured to control, under control of the switch control signal, the first node N1 to be connected to or disconnected from the first end of the second energy storage circuit 12; a second end of the second energy storage circuit 12 is electrically connected to the first voltage terminal V1.

In a specific implementation, the first voltage terminal may be the same voltage terminal as the power supply voltage terminal, or the first voltage terminal may be different from the power supply voltage terminal.

In operation of at least one embodiment of the pixel circuit shown in FIG. 1 of the present disclosure, in the high-brightness mode, under control of the switch control signal provided by the switch control terminal M, the switch control circuit 13 controls the first node N1 and the first terminal of the second energy storage circuit 12 to be disconnected, and the single end of the second energy storage circuit 12 is floating and does not participate in the related working process of the pixel circuit; in the low-brightness mode, under control of the switch control signal provided by the switch control terminal M, the switch control circuit 13 controls the first node N1 to be connected with the first end of the second energy storage circuit 12, one end of the second energy storage circuit 12 is connected with the first node N1, and the other end of the second energy storage circuit 12 is electrically connected to the first voltage terminal V1.

In at least one embodiment of the present disclosure, a first end of the second energy storage circuit is electrically connected to the first node; a control terminal of the switch control circuit is electrically connected to the switch control terminal, a first terminal of the switch control circuit is electrically connected to a second end of the second energy storage circuit, a second terminal of the switch control circuit is electrically connected to the first voltage terminal, and the switch control circuit is configured to control the second end of the second energy storage circuit to be connected to or disconnected from the first voltage terminal under control of the switch control signal.

Optionally, the switch control circuit includes a switching element; the first energy storage circuit includes a first capacitor, and the second energy storage circuit includes a second capacitor; a control terminal of the switching element is electrically connected to the switching control terminal, a first terminal of the switching element is electrically connected to a second end of the second capacitor, and a second terminal of the switching element is electrically connected to the first voltage terminal; and the switching element is configured to control, under control of the switching control signal, the first terminal of the switching element to be connected to or disconnected from the second terminal of the switching element; a first end of the first capacitor is electrically connected to the second node, and a second end of the first capacitor is electrically connected to the first node; a first end of the second capacitor is electrically connected to the first node.

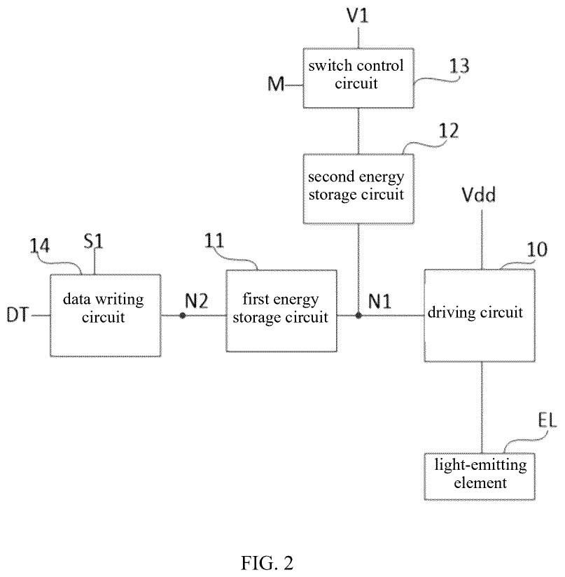

As shown in FIG. 2, the pixel circuit according to at least one embodiment of the present disclosure includes a light-emitting element EL, a driving circuit 10, a first energy storage circuit 11, a second energy storage circuit 12, a switch control circuit 13, and a data writing circuit 14; a control terminal of the driving circuit 10 is electrically connected to the first node N1, a first terminal of the driving circuit 10 is electrically connected to the power supply voltage terminal Vdd, a second terminal of the driving circuit 10 is electrically connected to the light-emitting element EL, and the driving circuit 10 is configured to drive the light-emitting element EL under control of the potential of the control terminal of the driving circuit 10; the data writing circuit 14 is electrically connected to the write control terminal S1, the data line DT, and the second node N2, respectively, and is configured to write the data voltage Vdt, provided by the data line DT, into the second node N2 under control of the write control signal provided by the write control terminal S1; a first end of the first energy storage circuit 11 is electrically connected to the second node N2, a second end of the first energy storage circuit 11 is electrically connected to the first node N1, and the first energy storage circuit 11 is configured to store electric energy; a first end of the second energy storage circuit 12 is electrically connected to the first node N1; a control terminal of the switch control circuit 13 is electrically connected to the switch control terminal M, a first terminal of the switch control circuit 13 is electrically connected to a second end of the second energy storage circuit 12, a second terminal of the switch control circuit 13 is electrically connected to the first voltage terminal V1, and the switch control circuit 13 is configured to control, under control of the switch control signal M, the second end of the second energy storage circuit 12 to be connected to or disconnected from the first voltage terminal V1.

In operation of at least one embodiment of the pixel circuit shown in FIG. 2 of the present disclosure, in the high-brightness mode, the switch control circuit 13 controls the second end of the second energy storage circuit 12 to be disconnected from the first voltage terminal V1 under control of the switch control signal provided by the switch control terminal M, and the single end of the second energy storage circuit 12 is floated and does not participate in the related working process of the pixel circuit; in the low-brightness mode, under control of the switch control signal provided by the switch control terminal M, the switch control circuit 13 controls the second end of the second energy storage circuit 12 to be connected with the first voltage terminal V1, one end of the second energy storage circuit 12 is electrically connected to the first node N1, and the other end of the second energy storage circuit 12 is connected with the first voltage terminal V1.

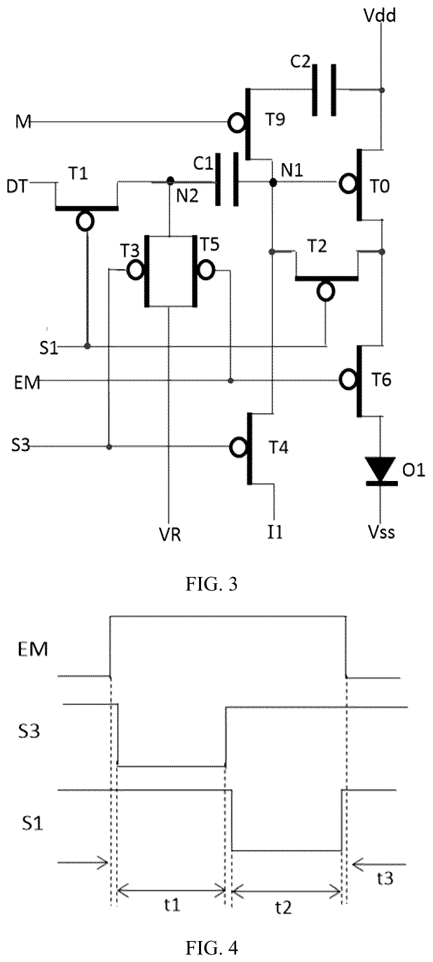

As shown in FIG. 3, on the basis of at least one embodiment of the pixel circuit shown in FIG. 1, the switch control circuit includes a switching element; the switching element is a switch transistor T9; the first energy storage circuit includes a first capacitor C1, and the second energy storage circuit includes a second capacitor C2; a gate electrode of the switching transistor T9 is electrically connected to the switching control terminal M, a source electrode of the switching transistor T9 is electrically connected to the first node N1, and a drain electrode of the switching transistor T9 is electrically connected to a first end of the second capacitor C2; a first end of the first capacitor C1 is electrically connected to the second node N2, and a second end of the first capacitor C1 is electrically connected to the first node N1; a second end of the second capacitor C2 is electrically connected to the power supply voltage terminal Vdd; the driving circuit includes a driving transistor T0, the data writing circuit includes a first transistor T1, and at least one embodiment of the pixel circuit may further include a second transistor T2, a third transistor T3, a fourth transistor T4, a fifth transistor T5, and a sixth transistor T6. A gate electrode of the driving transistor T0 is electrically connected to the first node N1, and a source electrode of the driving transistor T0 is electrically connected to the power supply voltage terminal Vdd; a gate electrode of the first transistor T1 is electrically connected to the write control terminal S1, a source electrode of the first transistor T1 is electrically connected to the data line DT, and a drain electrode of the first transistor T1 is electrically connected to the second node N2; a gate electrode of the second transistor T2 is electrically connected to the write control terminal S1, a source electrode of the second transistor T2 is electrically connected to the first node N1, and a drain electrode of the second transistor T2 is electrically connected to a drain electrode of the driving transistor T0; a gate electrode of the third transistor T3 is electrically connected to the initial control terminal S3, a source electrode of the third transistor T3 is electrically connected to the second node N2, a drain electrode of the third transistor T3 is electrically connected to a reference voltage terminal VR, and the reference voltage terminal VR is configured to provide a reference voltage Vref.

A gate electrode of the fourth transistor T4 is electrically connected to the initial control terminal S3, a source electrode of the fourth transistor T4 is electrically connected to the first node N1, a drain electrode of the fourth transistor T4 is electrically connected to the initial voltage terminal I1, and the initial voltage terminal I1 is configured to provide an initial voltage Vint.

A gate electrode of the fifth transistor T5 is electrically connected to the light-emitting control terminal EM, a source electrode of the fifth transistor T5 is electrically connected to the second node N2, and a drain electrode of the fifth transistor T5 is electrically connected to the reference voltage terminal VR.

A gate electrode of the sixth transistor T6 is electrically connected to the light-emitting control terminal EM, a source electrode of the sixth transistor T6 is electrically connected to a drain electrode of the driving transistor T0, and a drain electrode of the sixth transistor T6 is electrically connected to an anode of the organic light-emitting diode O1; the cathode of the organic light-emitting diode O1 is electrically connected to the low voltage terminal Vss.

In at least one embodiment of the pixel circuit shown in FIG. 3, the second voltage terminal is a low voltage terminal Vss, but is not limited thereto.

In at least one embodiment of the pixel circuit shown in FIG. 3, all transistors are P-type transistors, but not limited thereto.

As shown in FIG. 4, when at least one embodiment of the pixel circuit shown in FIG. 3 is in operation, a display period may include a reset stage T1, a threshold voltage acquisition stage T2, and a signal superposition stage T3 that are successively set.

In the reset stage T1, the EM provides a high voltage signal, S1 provides a high voltage signal, S3 provides a low voltage signal, T3 and T4 are both turned on to write the initial voltage Vint, provided by I1, into the first node N1, and write the reference voltage Vref, provided by the reference voltage Vr, to the second node N2.

In the threshold voltage acquisition stage T2, the EM provides a high voltage signal, S1 provides a low voltage signal, S3 provides a high voltage signal, T1 and T2 are turned on, DT provides a data voltage Vdt, and the Vdt is written into the second node N2; the first node N1 is connected to the drain electrode of T0; the potential of N1 is Vd+Vth, wherein Vd is the voltage value of the power supply voltage provided by the power supply voltage terminal Vdd, and Vth is the threshold voltage of T0.

In the signal superposition stage T3, the EM provides a low voltage signal, S1 and S3 both provide a high voltage signal, and T5 is turned on to write the reference voltage Vref, provided by the reference voltage terminal VR, into the second node N2;

In the signal superposition stage T3, when M provides a high voltage signal, T9 is turned off, the first terminal of C2 is disconnected from the first node N1, the first terminal of C2 is floating, C2 does not participate in the operation of the pixel circuit, the voltage variation δVN2 of N2 is equal to the voltage variation δVN1 of N1, δVN2 is equal to Vref−Vdt, δVN1 is equal to Vref−Vdt, and the potential of N1 is Vd+Vth+Vref−Vdt; in this case, δVN2 is equal to δVN1, so as to implement driving control with a large brightness dynamic range in a high brightness mode; when M provides a low voltage signal, T9 is turned on, the first end of C2 is in communication with the first node N1, δVN2 is equal to Vref-Vdt, δVN1 is equal to K1×δVN2, K1 is equal to C1z/(C1z+C2z), where K1 is the first voltage coefficient, C1z is the capacitance value of C1, and C2z is the capacitance value of C2; K1 is greater than 0 and less than 1, so as to realize the driving control with smaller grayscale difference in the low-brightness display mode.

During the signal superposition stage T3, the EM provides a low voltage signal, T6 is turned on, and T0 drives O1 to emit light.

In at least one embodiment of the pixel circuit shown in FIG. 3, the first voltage terminal and the power supply voltage terminal Vdd are the same voltage terminal, but not limited thereto.

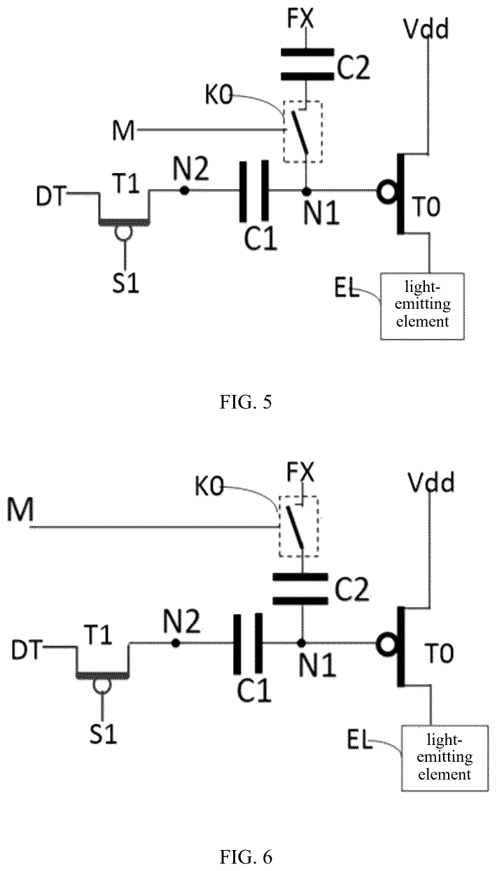

As shown in FIG. 5, on the basis of at least one embodiment of the pixel circuit shown in FIG. 1, the driving circuit includes a driving transistor T0, and the data writing circuit includes a first transistor T1; the switch control circuit includes a switching element K0; the first energy storage circuit includes a first capacitor C1, and the second energy storage circuit includes a second capacitor C2; a gate electrode of the driving transistor T0 is electrically connected to the first node N1, a source electrode of the driving transistor T0 is electrically connected to the power supply voltage terminal Vdd, and a drain electrode of the driving transistor T0 is electrically connected to the light-emitting element EL.

A control terminal of the switching element K0 is electrically connected to the switch control terminal M, a first terminal of the switching element K0 is electrically connected to the first node N1, and a second terminal of the switching element K0 is electrically connected to a first end of the second capacitor C2; the switching element K0 is configured to control, under control of the switch control signal, the first terminal of the switching element K0 to be connected to or disconnected from the second end of the second capacitor K0; a first end of the first capacitor C1 is electrically connected to the second node N2, and a second end of the first capacitor C1 is electrically connected to the first node N1; a second end of the second capacitor C2 is electrically connected to the reference potential terminal FX, and the reference potential terminal FX is configured to provide a reference potential Vfx.

A gate electrode of the first transistor T1 is electrically connected to the write control terminal S1, a source electrode of the first transistor T1 is electrically connected to the data line DT, and a drain electrode of the first transistor T1 is electrically connected to the second node N2.

In at least one embodiment of the pixel circuit shown in FIG. 5, T1 may be a P-type transistor.

In operation of at least one embodiment of the pixel circuit shown in FIG. 5 of the present disclosure, in the high-brightness mode, the switch control signal provided by the switch control terminal M is controlled such that K0 is turned off, C2 does not participate in the working process of the pixel circuit due to the loop being cut off and the single end being floating, and in the signal superposition stage, the voltage variation δVN2 of the second node N2 is coupled to the first node N1 through C1, δVN1 is equal to δVN2, the voltage division ratio of this coupling is N1, and then the first node N1 is maintained by the first capacitor C1 based on the potential of N2, and the potential of the second node N2 needs to be maintained after the potential of the second node N2 jumps.

In the low-brightness mode, the switch control signal provided by the switch control terminal M is controlled such that K0 is turned on, the first end of the second capacitor C2 is connected with the first node N1, the second end of the second capacitor C2 is electrically connected to the reference potential terminal FX, and the second capacitor C2 participates in the potential jump voltage-division of the first node N1; in the signal superposition stage, δVN1 is equal to K1×δVN2, K1 is the first voltage coefficient, K1 is equal to C1z/(C1z+C2z), the potential of the first node N1 is jointly maintained by the first capacitor C1 based on the potential of the second node N2 and by the second capacitor C2 based on the reference potential Vfx, and the maintained total capacitance capacity is C1z+C2z, and the second node N2 may also be floated after the potential of the second node N2 jumps in the low brightness mode, and in this case, the potential of N1 is only maintained by the second capacitor C2 based on the reference potential Vfx, holding the capacitance to be C2z.

In at least one embodiment of the present disclosure, the first voltage terminal may be a reference potential terminal, but is not limited thereto.

As shown in FIG. 6, on the basis of at least one embodiment of the pixel circuit shown in FIG. 2, the driving circuit 10 includes a driving transistor T0, and the data writing circuit 14 includes a first transistor T1; the switch control circuit 13 includes a switching element K0; the first energy storage circuit 11 includes a first capacitor C1, and the second energy storage circuit 12 includes a second capacitor C2; a gate electrode of the driving transistor T0 is electrically connected to the first node N1, a source electrode of the driving transistor T0 is electrically connected to the power supply voltage terminal Vdd, and a drain electrode of the driving transistor T0 is electrically connected to the light-emitting element EL.

A control terminal of the switching element K0 is electrically connected to the switch control terminal M, a first terminal of the switching element K0 is electrically connected to a second end of the second capacitor C2, and a second terminal of the switching element K0 is electrically connected to the reference potential terminal FX; a first end of the first capacitor C1 is electrically connected to the second node N2, and a second end of the first capacitor C1 is electrically connected to the first node N1; a first end of the second capacitor C2 is electrically connected to the first node N1; a gate electrode of the first transistor T1 is electrically connected to the write control terminal S1, a source electrode of the first transistor T1 is electrically connected to the data line DT, and a drain electrode of the first transistor T1 is electrically connected to the second node N2.

In at least one embodiment of the pixel circuit shown in FIG. 6, T1 may be a P-type transistor.

In operation of at least one embodiment of the pixel circuit shown in FIG. 6 of the present disclosure, in the high-brightness mode, the switch control signal provided by the switch control terminal M is controlled such that K0 is turned off, C2 does not participate in the working process of the pixel circuit due to the loop being cut off and the single end being floating, and in the signal superposition stage, the voltage variation δVN2 of the second node N2 is coupled to the first node N1 through C1, δVN1 is equal to δVN2, the voltage division ratio of the coupling is N1, and then the first node N1 is maintained by the first capacitor C1 based on the potential of N2, and the potential of the second node N2 needs to be maintained after the potential of the second node N2 jumps.

In the low-brightness mode, the switch control signal provided by the switch control terminal M is controlled so that K0 is turned on, the first end of the second capacitor C2 is connected to the first node N1, the second end of the second capacitor C2 is connected with the reference potential terminal FX, and the second capacitor C2 participates in the potential jump voltage-division of the first node N1; in the signal superposition stage, δVN1 is equal to K1×δVN2, K1 is the first voltage coefficient, K1 is equal to C1z/(C1z+C2z), the potential of the first node N1 is jointly maintained by the first capacitor C1 based on the potential of the second node N2 and by the second capacitor C2 based on the reference potential Vfx, and the maintained total capacitance is C1z+C2z, and the second node N2 may also be floated after the potential of the second node N2 jumps in the low brightness mode, and in this case, the potential of N1 is only maintained by the second capacitor C2 based on the reference potential Vfx, holding the capacitance to be C2z.

Optionally, the switch control circuit further includes a third terminal; the third terminal of the switch control circuit is electrically connected to the second node, and the switch control circuit is further configured to control, under control of the switch control signal, the second node to be connected to or disconnected from the second end of the second energy storage circuit.

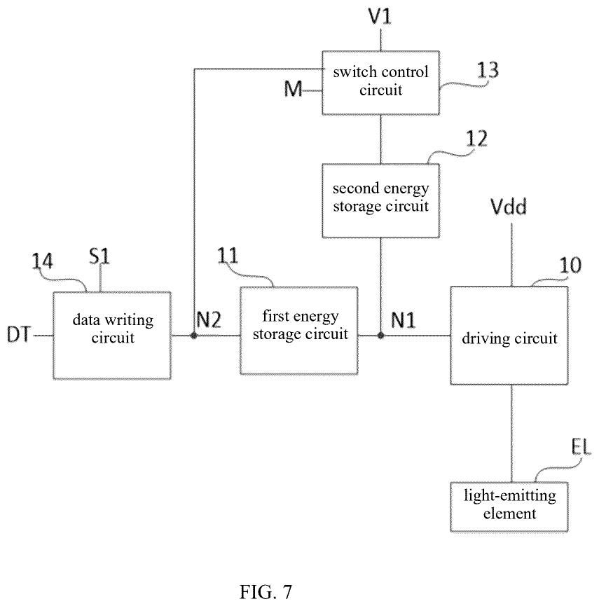

As shown in FIG. 7, on the basis of at least one embodiment of the pixel circuit shown in FIG. 2, the switch control circuit 13 further includes a third terminal; the third terminal of the switch control circuit 13 is electrically connected to the second node N2; the switch control circuit 13 is further configured to control the second node N2 to be connected to or disconnected from the second end of the second energy storage circuit 12 under control of the switch control signal.

In at least one embodiment of the present disclosure, the switch control circuit includes a double-throw switch element; the first energy storage circuit includes a first capacitor, and the second energy storage circuit includes a second capacitor; a first end of the first capacitor is electrically connected to the second node, and a second end of the first capacitor is electrically connected to the first node; a first end of the second capacitor is electrically connected to the first node; a control terminal of the double-throw switch element is electrically connected to a switch control terminal, a first terminal of the double-throw switch element is electrically connected to a second end of the second capacitor, a second terminal of the double-throw switch element is electrically connected to the first voltage terminal, and a third terminal of the double-throw switch element is electrically connected to the second node.

The double-throw switch element is configured to control a first terminal of the double-throw switch element to be connected with a second terminal of the double-throw switch element or a third terminal of the double-throw switch element under control of the switch control signal.

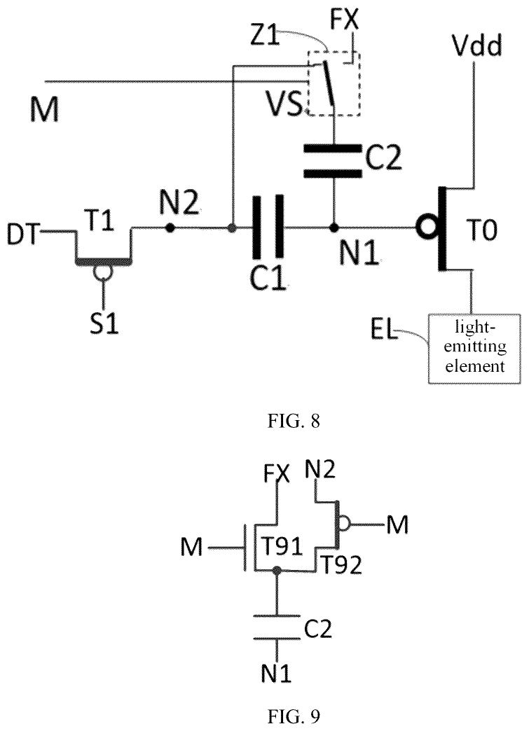

As shown in FIG. 8, on the basis of at least one embodiment of the pixel circuit shown in FIG. 7, the driving circuit 10 includes a driving transistor T0, and the data writing circuit 14 includes a first transistor T1; the switch control circuit 13 includes a double-throw switch element Z1; the first energy storage circuit 11 includes a first capacitor C1, and the second energy storage circuit 12 includes a second capacitor C2; a gate electrode of the driving transistor T0 is electrically connected to the first node N1, a source electrode of the driving transistor T0 is electrically connected to the power supply voltage terminal Vdd, and a drain electrode of the driving transistor T0 is electrically connected to the light-emitting element EL.

A control terminal of the double-throw switch element Z1 is electrically connected to the switch control terminal M, a first terminal of the double-throw switch element Z1 is electrically connected to a second end of the second capacitor C2, a second terminal of the double-throw switch element Z1 is electrically connected to a reference potential terminal FX, a third terminal of the double-throw switch element Z1 is electrically connected to the second node N2, and the reference potential terminal FX is used to provide a reference potential Vfx; the double-throw switch element Z1 is configured to control the first terminal of the double-throw switch element Z1 to be connected with the second terminal of the double-throw switch element Z1 or the third terminal of the double-throw switch element Z1 under control of the switch control signal.

A first end of the first capacitor C1 is electrically connected to the second node N2, and a second end of the first capacitor C1 is electrically connected to the first node N1; a first end of the second capacitor C2 is electrically connected to the first node N1.

A gate electrode of the first transistor T1 is electrically connected to the write control terminal S1, a source electrode of the first transistor T1 is electrically connected to the data line DT, and a drain electrode of the first transistor T1 is electrically connected to the second node N2.

In at least one embodiment of the pixel circuit shown in FIG. 8, T1 may be a P-type transistor.

In operation of at least one embodiment of the pixel circuit shown in FIG. 8 of the present disclosure, in the high-brightness mode, the switch control signal provided by the switch control terminal M is controlled, so that Z1 control the second end of C2 to be in communication with N2, and C1 and C2 are connected in parallel to form a capacitor for signal coupling and holding; in the signal superposition stage, the voltage variation δVN2 of the second node N2 is coupled to the first node N1 through C1, δVN1 is equal to δVN2, the voltage division ratio of this coupling is N1, then the first node N1 is held by the parallel capacitor of C1 and C2 based on the reference potential Vfx, the capacitance of the capacitor is kept to be C1z+C2z, and the potential of the second node N2 needs to be maintained after the potential of the second node N2 jumps.

In the low-brightness mode, the switch control signal provided by the switch control terminal M is controlled, so that Z1 controls the second end of the C2 to be connected with the FX, and the second capacitor C2 participates in the potential jump voltage-division of the first node N1. In the signal superposition stage, δVN1 is equal to K1×δVN2, K1 is the first voltage coefficient, K1 is equal to C1z/(C1z+C2z), the potential of the first node N1 is jointly maintained by the first capacitor C1 based on the potential of the second node N2, and by the second capacitor C2 based on the reference potential Vfx, and the total capacitance is maintained to be C1z+C2z; and the second node N2 may also be floated after the potential of the second node N2 jumps in the low brightness mode, and in this case, the potential of N1 is only maintained by the second capacitor C2 based on the reference potential Vfx, holding the capacitance to be C2z.

In at least one embodiment of the pixel circuit shown in FIG. 8 of the present disclosure, capacitance that are maintained are C1z+C2z and C2z in the high brightness mode and in the low brightness mode, respectively. Alternatively, capacitance that are maintained are C1z+C2z, C1z+C2z; under the conditions of C2z>>C1z, the capacitance difference of the maintained capacitances between the high and low brightness modes is not large, which facilitates the signal stability design of the pixel circuit.

As shown in FIG. 9, at least one embodiment of the double-throw switch element may include a first switch transistor T91 and a second switch transistor T92.

The gate electrode of T91 is electrically connected to the switch control terminal M, the source electrode of T91 is electrically connected to the second end of the second capacitor C2, and the drain electrode of T91 is electrically connected to the reference potential terminal FX.

The gate electrode of T92 is electrically connected to the switch control terminal M, the source electrode of T92 is electrically connected to the second end of the second capacitor C2, and the drain electrode of T92 is electrically connected to the second node N2.

In at least one embodiment of the double-throw switching element shown in FIG. 9, T91 is an N-type transistor, and T92 is a P-type transistor.

At least one embodiment of the double-throw switch element shown in FIG. 9 is in operation. When the switch control terminal M provides a high voltage signal, T91 is turned on, T92 is turned off, and the second end of the second capacitor C2 is in communication with the reference potential terminal FX; when the switch control terminal M provides a low voltage signal, T92 is turned on, T91 is turned off, and the second end of the second capacitor C2 is in communication with the second node N2.

In at least one embodiment of the present disclosure, T91 may also be a P-type transistor, and T92 may also be an N-type transistor.

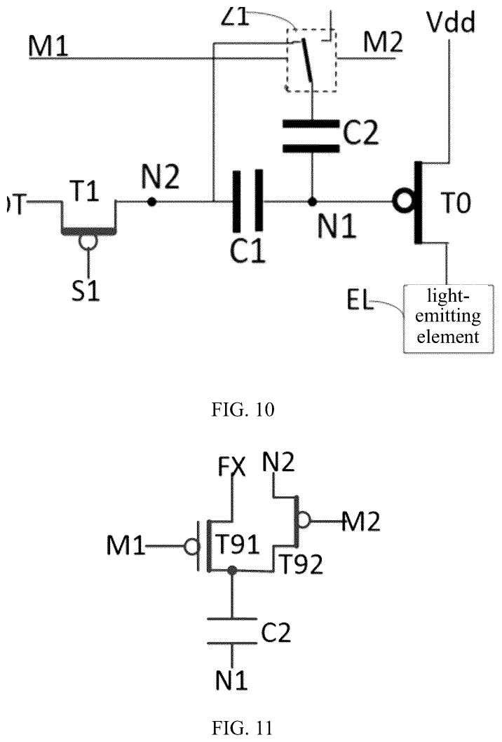

As shown in FIG. 10, on the basis of at least one embodiment of the pixel circuit shown in FIG. 7, the driving circuit 10 includes a driving transistor T0, and the data writing circuit 14 includes a first transistor T1; the switch control circuit 13 includes a double-throw switch element Z1; the first energy storage circuit 11 includes a first capacitor C1, and the second energy storage circuit 12 includes a second capacitor C2; a gate electrode of the driving transistor T0 is electrically connected to the first node N1, a source electrode of the driving transistor T0 is electrically connected to the power supply voltage terminal Vdd, and a drain electrode of the driving transistor T0 is electrically connected to the light-emitting element EL; a first control terminal of the double-throw switch element Z1 is electrically connected to the first switch control terminal M1, a second terminal of the double-throw switch element Z1 is electrically connected to the second switch control terminal M2, a first terminal of the double-throw switch element Z1 is electrically connected to a second end of the second capacitor C2, a second terminal of the double-throw switch element Z1 is electrically connected to the reference potential terminal FX, and a third terminal of the double-throw switch element Z1 is electrically connected to the second node N2; the reference potential terminal FX is configured to provide a reference potential Vfx.

The double-throw switch element Z1 is configured to control a first terminal of the double-throw switch element Z1 to be communicated with a second terminal of the double-throw switch element Z1 or a third terminal of the double-throw switch element Z1 under control of a first switch control signal provided by the first switch control terminal M1 and a second switch control signal provided by the second switch control terminal M2.

A first end of the first capacitor C1 is electrically connected to the second node N2, and a second end of the first capacitor C1 is electrically connected to the first node N1.

A first end of the second capacitor C2 is electrically connected to the first node N1.

A gate electrode of the first transistor T1 is electrically connected to the write control terminal S1, a source electrode of the first transistor T1 is electrically connected to the data line DT, and a drain electrode of the first transistor T1 is electrically connected to the second node N2.

In at least one embodiment of the pixel circuit shown in FIG. 10, T1 may be a P-type transistor.

In at least one embodiment of the pixel circuit shown in FIG. 10 of the present disclosure, in operation, in a high-brightness mode, a first switch control signal provided by the first switch control terminal M1 and a second switch control signal provided by the second switch control terminal M2 are controlled, so that Z1 controls the second end of C2 to be connected with N2, and C1 and C2 are connected in parallel to form a capacitor for signal coupling and holding; in the signal superposition stage, the voltage variation δVN2 of the second node N2 is coupled to the first node N1 through C1, δVN1 is equal to δVN2, the voltage-division ratio of the coupling is N1, then the first node N1 is held by the parallel capacitor of C1 and C2 based on the reference potential Vfx, the capacitance capacity of the parallel capacitor is kept to be C1z+C2z, and the potential of the second node N2 needs to be maintained after the potential of the second node N2 jumps.

In the low-brightness mode, the first switch control signal provided by the first switch control terminal M1 and the second switch control signal provided by the second switch control terminal M2 are controlled, so that Z1 controls the second end of the C2 to be connected with the FX, and the second capacitor C2 participates in the potential jump voltage-division of the first node N1; in the signal superposition stage, δVN1 is equal to K1×δVN2, K1 is the first voltage coefficient, K1 is equal to C1z/(C1z+C2z), the potential of the first node N1 is jointly maintained by the first capacitor C1 based on the potential of the second node N2 and by the second capacitor C2 based on the reference potential Vfx, and the total capacitance capacity that is maintained is C1z+C2z. The second node N2 may also be floated after the potential of the second node N2 jumps in the low brightness mode, and in this case, the potential of N1 is only maintained by the second capacitor C2 based on the reference potential Vfx, and the maintained capacitance is C2z.

In at least one embodiment of the pixel circuit shown in FIG. 10 of the present disclosure, the maintained capacitances are C1z+C2z and C2z in the high-brightness mode and in the low-brightness mode, respectively; alternatively, the maintained capacitances are C1z+C2z and C1z+C2z in the high-brightness mode and in the low-brightness mode, respectively; under the condition of C2z>>C1z, the capacitance difference of the maintained capacitances between the high and low brightness modes is not large, which facilitates the signal stability design of the pixel circuit.

As shown in FIG. 11, at least one embodiment of the double-throw switch element may include a first switch transistor T91 and a second switch transistor T92.

The gate electrode of T91 is electrically connected to the first switch control terminal M1, the source electrode of T91 is electrically connected to the second end of the second capacitor C2, and the drain electrode of T91 is electrically connected to the reference potential terminal FX.

The gate electrode of T92 is electrically connected to the second switch control terminal M2, the source electrode of T92 is electrically connected to the second end of the second capacitor C2, and the drain electrode of T92 is electrically connected to the second node N2.

In at least one embodiment of the double-throw switching element shown in FIG. 11, T91 and T92 are both P-type transistors.

In operation of at least one embodiment of the double-throw switch element shown in FIG. 11, when the first switch control terminal M1 provides a low voltage signal, the second switch control terminal M2 provides a high voltage signal, T91 is turned on, T92 is turned off, and the second end of the second capacitor C2 is in communication with the reference potential terminal FX; when the first switch control terminal M1 provides a high voltage signal, the second switch control terminal M2 provides a low voltage signal to provide a low voltage signal, T92 is turned on, T91 is turned off, and the second end of the second capacitor C2 is in communication with the second node N2.

In at least one embodiment of the present disclosure, T91 and T92 may also be N-type transistors.

The pixel circuit according to at least one embodiment of the present disclosure may further include a third energy storage circuit; a first end of the third energy storage circuit is electrically connected to the first node, a second end of the third energy storage circuit is electrically connected to the first voltage terminal, and the third energy storage circuit is configured to store electric energy.

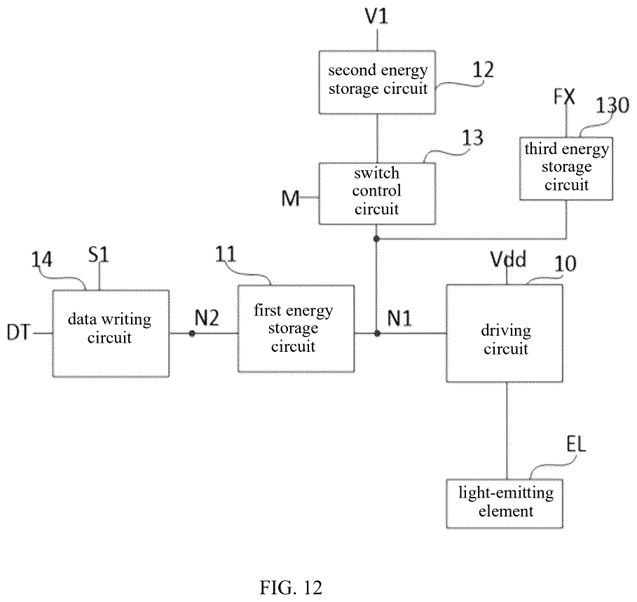

As shown in FIG. 12, on the basis of at least one embodiment of the pixel circuit shown in FIG. 1, the pixel circuit according to at least one embodiment of the present disclosure may further include a third energy storage circuit 130; a first end of the third energy storage circuit 130 is electrically connected to the first node N1, a second end of the third energy storage circuit 130 is electrically connected to the reference potential terminal FX, and the third energy storage circuit 130 is configured to store electric energy.

At least one embodiment of the pixel circuit shown in FIG. 12 has independent coupling capacitance and holding capacitance in the high brightness mode and the low brightness mode, but the holding capacitance is controlled by the mode signal to be adjustable, thereby generating different voltage-division ratios in different modes.

In operation of at least one embodiment of the pixel circuit shown in FIG. 12 of the present disclosure, in the high-brightness mode, under control of the switch control signal provided by the switch control terminal M, the switch control circuit 13 controls the first node N1 to be disconnected from the first terminal of the second energy storage circuit 12, and the single terminal of the second energy storage circuit 12 is floating and does not participate in the related working process of the pixel circuit; in the low-brightness mode, under control of the switch control signal provided by the switch control terminal M, the switch control circuit 13 controls the first node N1 to be in communication with the first end of the second energy storage circuit 12, one end of the second energy storage circuit 12 is in communication with the first node N1, and the other end of the second energy storage circuit 12 is electrically connected to the first voltage terminal V1.

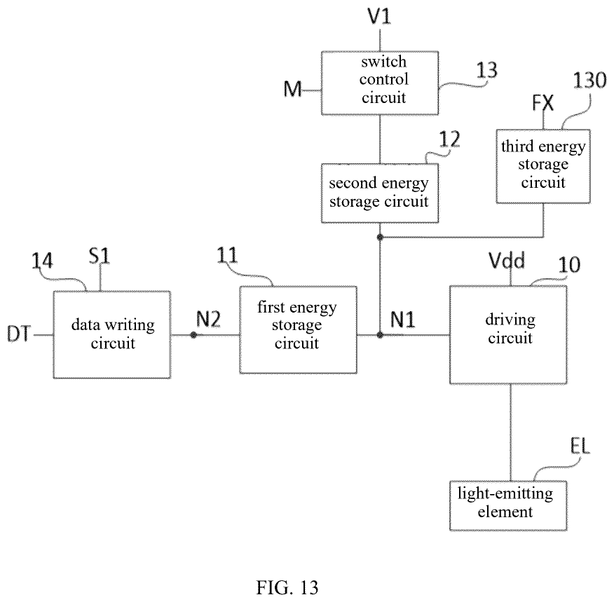

As shown in FIG. 13, on the basis of at least one embodiment of the pixel circuit shown in FIG. 2, the pixel circuit according to at least one embodiment of the present disclosure may further include a third energy storage circuit 130; a first end of the third energy storage circuit 130 is electrically connected to the first node N1, a second end of the third energy storage circuit 130 is electrically connected to the reference potential terminal FX, and the third energy storage circuit 130 is configured to store electric energy.

At least one embodiment of the pixel circuit shown in FIG. 13 has independent coupling capacitance and holding capacitance in the high brightness mode and the low brightness mode, but the holding capacitance is controlled by the mode signal to be adjustable, thereby generating different voltage division ratios in different modes.

In operation of at least one embodiment of the pixel circuit shown in FIG. 13 of the present disclosure, in the high-brightness mode, the switch control circuit 13 controls the second end of the second energy storage circuit 12 to be disconnected from the first voltage terminal V1 under control of the switch control signal provided by the switch control terminal M, and the single end of the second energy storage circuit 12 is floated without participating in the related working process of the pixel circuit; in the low-brightness mode, under control of the switch control signal provided by the switch control terminal M, the switch control circuit 13 controls the second end of the second energy storage circuit 12 to be connected with the first voltage terminal V1, one end of the second energy storage circuit 12 is electrically connected to the first node N1, and the other end of the second energy storage circuit 12 is in communication with the first voltage terminal V1.

Optionally, the third energy storage circuit includes a third capacitor; a first end of the third capacitor is electrically connected to the first node, and a second end of the third capacitor is electrically connected to the first voltage terminal.

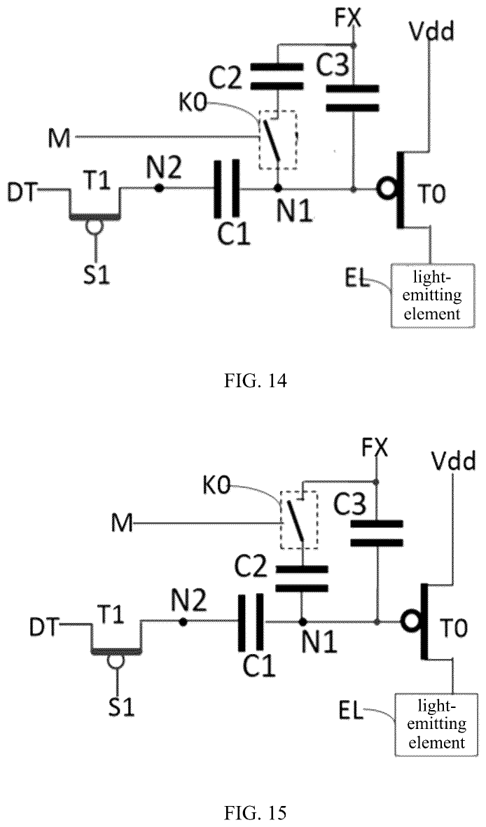

As shown in FIG. 14, on the basis of at least one embodiment of the pixel circuit shown in FIG. 5, the pixel circuit according to at least one embodiment of the present disclosure further includes a third energy storage circuit, and the third energy storage circuit includes a third capacitor C3; the first end of C3 is electrically connected to the first node N1, and the second end of C3 is electrically connected to the reference potential terminal FX.

In at least one embodiment of the pixel circuit shown in FIG. 14, T1 may be a P-type transistor.

In operation of at least one embodiment of the pixel circuit shown in FIG. 14 of the present disclosure, in the high-brightness mode, the switch control signal provided by the switch control terminal M is controlled such that K0 is turned off, C2 does not participate in the working process of the pixel circuit due to the loop being cut off and the single end being float, and in the signal superposition stage, the voltage variation δVN2 of the second node N2 is coupled to the first node N1 through C1, δVN1 is equal to K2×δVN2, K2 is the second voltage coefficient, K2 is equal to C1z/(C1z+C3z), C1z is the capacitance value of C1, and C3z is the capacitance value of C3; in the high-brightness mode, after the voltage of N1 jumps, the second node N2 may be float, and in this case, the potential of the first node N1 is maintained by the third capacitor C3 based on the reference potential Vfx, and the capacitance capacity is maintained to be C3z ; or, in the high-brightness mode, after the voltage of N1 jumps, the potential of the second node N2 is maintained, the potential of the first node N1 may be maintained by the first capacitor C1 and the third capacitor C3, and the capacity of the maintained capacitance is C1z+C3z; in the low-brightness mode, the switch control signal provided by the switch control terminal M is controlled so that K0 is turned on, the first end of the second capacitor C2 is connected with the first node N1, the second end of the second capacitor C2 is electrically connected to the reference potential terminal FX, and the second capacitor C2 and the third capacitor C3 are connected in parallel to participate in the potential jump voltage-division of the first node N1; in the signal superposition stage, δVN1 is equal to K3×δVN2, K3 is the third voltage coefficient, and K3 is equal to C1z/(C1z+C2z +C3z), where C1z is the capacitance value of C1, C2z is the capacitance value of C2, and C3z is the capacitance value of C3; in the low-brightness mode, after the voltage of N1 jumps, the second node N2 may be floating, the potential of the first node N1 is maintained by the parallel capacitor of C2 and C3 based on the reference potential Vfx, and the capacity of the maintained capacitance is kept to be C2z +C3z; or, in the low-brightness mode, after the voltage of N1 jumps, the potential of the second node N2 is maintained, the potential of the first node N1 may be maintained by the first capacitor C1, the second capacitor C2, and the third capacitor C3, and the capacitance capacity that is maintained is C1z +C2z +C3z.

By appropriately setting C1z, C2z, and C3z, K2 and K3 which are different may be obtained, which are suitable for the high-brightness display mode and the low-brightness display mode, respectively.

As shown in FIG. 15, on the basis of at least one embodiment of the pixel circuit shown in FIG. 6, the pixel circuit according to at least one embodiment of the present disclosure further includes a third energy storage circuit, and the third energy storage circuit includes a third capacitor C3.

The first terminal of C3 is electrically connected to the first node N1, and the second terminal of C3 is electrically connected to the reference potential terminal FX.

In at least one embodiment of the pixel circuit shown in FIG. 15, T1 may be a P-type transistor.

In operation of at least one embodiment of the pixel circuit shown in FIG. 15 of the present disclosure, in the high-brightness mode, the switch control signal provided by the switch control terminal M is controlled such that K0 is turned off, C2 does not participate in the working process of the pixel circuit due to the loop being cut off and single-end being float, and in the signal superposition stage, the voltage variation δVN2 of the second node N2 is coupled to the first node N1 through C1, δVN1 is equal to K2×δVN2, K2 is the second voltage coefficient, K2 is equal to C1z/(C1z+C3z), C1z is the capacitance value of C1, and C3z is the capacitance value of C3.

In the high-brightness mode, after the voltage of N1 jumps, the second node N2 may be float, and in this case, the potential of the first node N1 is maintained by the third capacitor C3 based on the reference potential Vfx, and the capacitance capacity of C3 is kept to be C3z ; Alternatively, in the high-brightness mode, after the voltage of N1 jumps, the potential of the second node N2 is maintained, the potential of the first node N1 may be maintained by the first capacitor C1 and the third capacitor C3, and the capacitance capacity of the capacitor is kept to be C1z+C3z;
in the low-brightness mode, the switch control signal provided by the switch control terminal M is controlled so that K0 is turned on, the first end of the second capacitor C2 is electrically connected to the first node N1, the second end of the second capacitor C2 is in communication with the reference potential terminal FX, and the second capacitor C2 and the third capacitor C3 are connected in parallel to participate in the potential jump voltage-division of the first node N1; in the signal superposition stage, δVN1 is equal to K3×δVN2, K3 is the third voltage coefficient, and K3 is equal to C1z/(C1z+C2z+C3z), where C1z is the capacitance value of C1, C2z is the capacitance value of C2, and C3z is the capacitance value of C3;
in the low-brightness mode, after the voltage of N1 jumps, the second node N2 may be float, the potential of the first node N1 is maintained by the parallel capacitor of C2 and C3 based on the reference potential Vfx, and the capacitance capacity of the capacitor is kept to be C2z+C3z ; alternatively, in the low-brightness mode, after the voltage of N1 jumps, the potential of the second node N2 is maintained, the potential of the first node N1 may be maintained by the first capacitor C1, the second capacitor C2, and the third capacitor C3, and the capacitance capacity is maintained as C1z+C2z+C3z.

By appropriately setting C1z, C2z, and C3z, K2 and K3 which are different may be obtained, which are suitable for high-brightness mode display mode and low-brightness display mode, respectively.

At least one embodiment of the pixel circuit shown in FIG. 14 and at least one embodiment of the pixel circuit shown in FIG. 15 are equivalent in terms of coupling, voltage division, and retention functions, but have differences in characteristics such as parasitic effects under specific pixel circuit layout conditions.

The pixel circuit according to at least one embodiment of the present disclosure further includes a first initialization circuit, a second initialization circuit, a compensation control circuit, and a light-emitting control circuit;
the first initialization circuit is electrically connected to a first initial control terminal, a reference voltage terminal, and the second node, respectively, and is configured to control the reference voltage terminal to provide a reference voltage to the second node under control of a first initial control signal provided by the first initial control terminal; the second initialization circuit is electrically connected to the second initial control terminal, the initial voltage terminal, and the first node, respectively, and is configured to control the initial voltage terminal to provide an initial voltage to the first node under control of a second initial control signal provided by the second initial control terminal; the compensation control circuit is electrically connected to the compensation control terminal, the first node, and the second terminal of the driving circuit, respectively, and is configured to control the first node to be connected to or disconnected from the second terminal of the driving circuit under control of the compensation control signal provided by the compensation control terminal; the light-emitting control circuit is electrically connected to the light-emitting control terminal, a second terminal of the driving circuit, and a first electrode of the light-emitting element, and configured to control, under control of the light-emitting control signal, the second terminal of the driving circuit to be connected to or disconnected from the first electrode of the light-emitting element; a second electrode of the light-emitting element is electrically connected to the second voltage terminal.

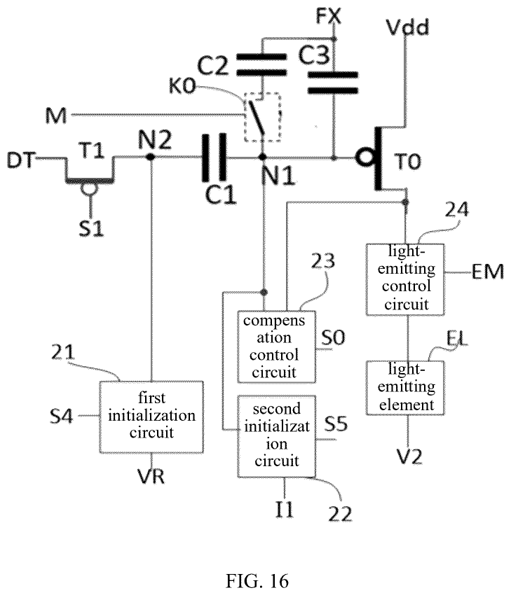

As shown in FIG. 16, on the basis of at least one embodiment of the pixel circuit shown in FIG. 14, the pixel circuit according to at least one embodiment of the present disclosure further includes a first initialization circuit 21, a second initialization circuit 22, a compensation control circuit 23, and a light-emitting control circuit 24.

The first initialization circuit 21 is electrically connected to the first initial control terminal S4, the reference voltage terminal VR, and the second node N2, respectively, and is configured to control the reference voltage terminal VR to provide the reference voltage Vref to the second node N2 under control of the first initial control signal provided by the first initial control terminal S4.

The second initialization circuit 22 is electrically connected to the second initial control terminal S5, the initial voltage terminal I1, and the first node N1, respectively, and is configured to control the initial voltage terminal I1 to provide an initial voltage Vint to the first node N1 under control of a second initial control signal provided by the second initial control terminal S5.

The compensation control circuit 23 is electrically connected to the compensation control terminal S0, the first node N1, and the second terminal of the driving circuit 10, respectively, and is configured to control the first node N1 to be connected to or disconnected from the second terminal of the driving circuit 10 under control of the compensation control signal provided by the compensation control terminal S0.

The light-emitting control circuit 24 is electrically connected to the light-emitting control terminal EM, a second terminal of the driving circuit 10, and a first electrode of the light-emitting element EL, respectively, and configured to control, under control of the light-emitting control signal, the second terminal of the driving circuit 10 to be connected to or disconnected from the first electrode of the light-emitting element EL.

A second electrode of the light-emitting element EL is electrically connected to the second voltage terminal V2.

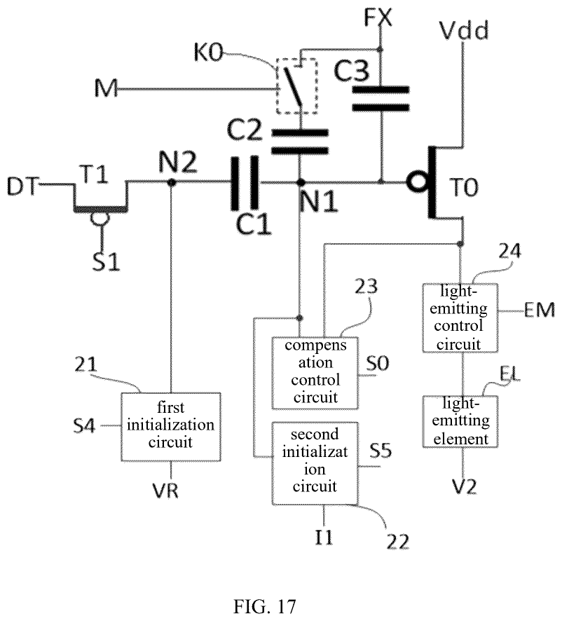

As shown in FIG. 17, on the basis of at least one embodiment of the pixel circuit shown in FIG. 15, the pixel circuit according to at least one embodiment of the present disclosure further includes a first initialization circuit 21, a second initialization circuit 22, a compensation control circuit 23, and a light-emitting control circuit 24.

The first initialization circuit 21 is electrically connected to the first initial control terminal S4, the reference voltage terminal VR, and the second node N2, respectively, and is configured to control the reference voltage terminal VR to provide the reference voltage Vref to the second node N2 under control of the first initial control signal provided by the first initial control terminal S4.

The second initialization circuit 22 is electrically connected to the second initial control terminal S5, the initial voltage terminal I1, and the first node N1, respectively, and is configured to control the initial voltage terminal I1 to provide an initial voltage Vint to the first node N1 under control of a second initial control signal provided by the second initial control terminal S5.

The compensation control circuit 23 is electrically connected to the compensation control terminal S0, the first node N1, and the second terminal of the driving circuit 10, respectively, and is configured to control the first node N1 to be connected to or disconnected from the second terminal of the driving circuit 10 under control of the compensation control signal provided by the compensation control terminal S0.

The light-emitting control circuit 24 is electrically connected to the light-emitting control terminal EM, a second terminal of the driving circuit 10, and a first electrode of the light-emitting element EL, respectively, and configured to control, under control of the light-emitting control signal, the second terminal of the driving circuit 10 to be connected to or disconnected from the first electrode of the light-emitting element EL.

A second electrode of the light-emitting element EL is electrically connected to the second voltage terminal V2.

Optionally, the compensation control terminal and the first initial control terminal are the same control terminal; the driving circuit includes a driving transistor, the data writing circuit includes a first transistor, the compensation control circuit includes a second transistor, the first initialization circuit includes a third transistor, the second initialization circuit includes a fourth transistor, and the light emitting control circuit includes a sixth transistor; the light emitting element is an organic light-emitting diode; a gate electrode of the driving transistor is electrically connected to the first node, and a first electrode of the driving transistor is electrically connected to the power supply voltage terminal; a gate electrode of the first transistor is electrically connected to a write control terminal, a first electrode of the first transistor is electrically connected to a data line, and a second electrode of the first transistor is electrically connected to a second node; a gate electrode of the second transistor is electrically connected to the first initial control terminal, a first electrode of the second transistor is electrically connected to the first node, and a second electrode of the second transistor is electrically connected to a second electrode of the driving transistor; a gate electrode of the third transistor is electrically connected to the first initial control terminal, a first electrode of the third transistor is electrically connected to the second node, and a second electrode of the third transistor is electrically connected to a reference voltage terminal; a gate electrode of the fourth transistor is electrically connected to the second initial control terminal, a first electrode of the fourth transistor is electrically connected to the first node, and a second electrode of the fourth transistor is electrically connected to an initial voltage terminal.

A gate electrode of the sixth transistor is electrically connected to the light-emitting control terminal, a first electrode of the sixth transistor is electrically connected to a second electrode of the driving transistor, and a second electrode of the sixth transistor is electrically connected to an anode of the organic light-emitting diode;

A cathode of the organic light-emitting diode is electrically connected to the second voltage terminal.

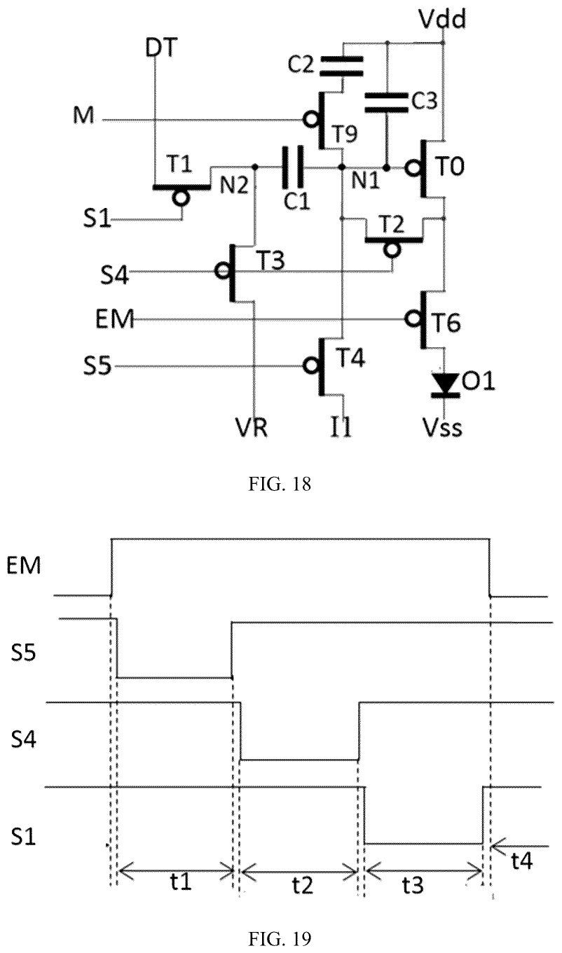

As shown in FIG. 18, on the basis of at least one embodiment of the pixel circuit shown in FIG. 16, the switching element is a switching transistor T9.

A gate electrode of the switching transistor T9 is electrically connected to the switching control terminal M, a source electrode of the switching transistor T9 is electrically connected to the first node N1, and a drain electrode of the switching transistor T9 is electrically connected to a first end of the second capacitor C2.

The compensation control circuit includes a second transistor T2, the first initialization circuit includes a third transistor T3, the second initialization circuit includes a fourth transistor T4, and the light-emitting control circuit includes a sixth transistor T6; the light-emitting element is an organic light-emitting diode O1.

A gate electrode of the second transistor T2 is electrically connected to the first initial control terminal S4, a source electrode of the second transistor T2 is electrically connected to the first node N1, and a drain electrode of the second transistor T2 is electrically connected to a drain electrode of the driving transistor T0.

A gate electrode of the third transistor T3 is electrically connected to the first initial control terminal S4, a source electrode of the third transistor T3 is electrically connected to the second node N2, a drain electrode of the third transistor T3 is electrically connected to a reference voltage terminal VR, and the reference voltage terminal VR is configured to provide a reference voltage Vref.

A gate electrode of the fourth transistor T4 is electrically connected to the second initial control terminal S5, a source electrode of the fourth transistor T4 is electrically connected to the first node N1, a second electrode of the fourth transistor T4 is electrically connected to the initial voltage terminal I1, and the initial voltage terminal I1 is configured to provide an initial voltage Vint.

A gate electrode of the sixth transistor T6 is electrically connected to the light-emitting control terminal EM, a source electrode of the sixth transistor T6 is electrically connected to a drain electrode of the driving transistor T0, and a drain electrode of the sixth transistor T6 is electrically connected to an anode of the organic light-emitting diode O1.

The cathode of the organic light-emitting diode O1 is electrically connected to the low voltage terminal Vss.

In at least one embodiment of the pixel circuit shown in FIG. 18, all transistors are P-type transistors, but not limited thereto.

As shown in FIG. 19, during operation of at least one embodiment of the pixel circuit shown in FIG. 18, the display period may include a reset stage T1, a threshold voltage acquisition stage T2, a signal superposition stage T3, and a light-emitting stage T4 that are successively set.

In the reset stage T1, the EM provides a high voltage signal, S5 provides a low voltage signal, S1 and S4 both provide a high voltage signal, and T4 is turned on to write Vint into the first node N1.

In the threshold voltage acquisition stage T2, the EM provides a high voltage signal, S4 provides a low voltage signal, S1 and S5 both provide high voltage signals, T2 and T3 are both turned on to write Vref into the second node N2 and control connection between the first node N1 and the drain electrode of T3, the potential of N1 is Vd+Vth, Vd is the voltage value of the power supply voltage provided by the power supply voltage Vdd, and Vth is the threshold voltage of T0.

In the signal superposition stage T3, the EM provides a high voltage signal, S1 provides a low voltage signal, S4 and S5 both provide high voltage signals, T1 is turned on, DT provides a data voltage Vdata to the second node N2, and the potential of N1 changes correspondingly.

In the signal superposition stage T3, in the high-brightness mode, the high-voltage signal is provided by controlling the switch control terminal M, so that T9 is turned off, C2 does not participate in the working process of the pixel circuit due to the loop being cut off and single-end is float, and in the signal superposition stage, the voltage variation δVN2 of the second node N2 is coupled to the first node N1 through C1, δVN1 is equal to K2×δVN2, K2 is the second voltage coefficient, K2 is equal to C1z (C1z +C3z), C1z is the capacitance value of C1, and C3z is the capacitance value of C3.

In the low-brightness mode, the low-voltage signal is provided by controlling the switch control terminal M, so that T9 is turned on, the first end of the second capacitor C2 is connected the first node N1, the second end of the second capacitor C2 is electrically connected to the reference potential terminal FX, and the second capacitor C2 and the third capacitor C3 are connected in parallel to participate in the potential jump voltage-division of the first node N1; δVN1 is equal to K3×δVN2, K3 is a third voltage coefficient, K3 is equal to C1z/(C1z+C2z+C3z), C1z is a capacitance value of C1, C2z is a capacitance value of C2, and C3z is a capacitance value of C3.

In the light emitting phase T4, the EM provides a low voltage signal, S1 provides a high voltage signal, S4 and S5 both provide high voltage signals, and T0 drives O1 to emit light.

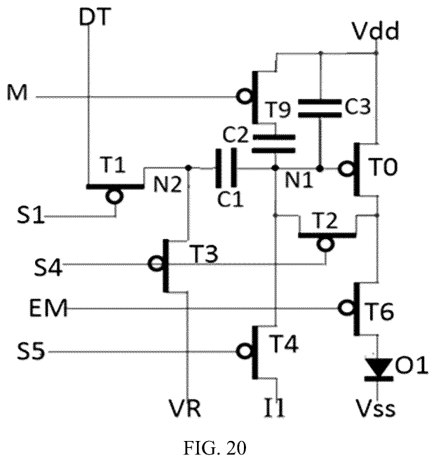

As shown in FIG. 20, on the basis of at least one embodiment of the pixel circuit shown in FIG. 17, the switching element is a switching transistor T9.

A gate electrode of the switching transistor T9 is electrically connected to the switching control terminal M, a source electrode of the switching transistor T9 is electrically connected to a first end of the second capacitor C2, and a drain electrode of the switching transistor T9 is electrically connected to the reference potential terminal FX.

The compensation control circuit includes a second transistor T2, the first initialization circuit includes a third transistor T3, the second initialization circuit includes a fourth transistor T4, and the light-emitting control circuit includes a sixth transistor T6; the light-emitting element is an organic light-emitting diode O1; a gate electrode of the second transistor T2 is electrically connected to the first initial control terminal S4, a source electrode of the second transistor T2 is electrically connected to the first node N1, and a drain electrode of the second transistor T2 is electrically connected to a drain electrode of the driving transistor T0.

A gate electrode of the third transistor T3 is electrically connected to the first initial control terminal S4, a source electrode of the third transistor T3 is electrically connected to the second node N2, a drain electrode of the third transistor T3 is electrically connected to a reference voltage terminal VR, and the reference voltage terminal VR is configured to provide a reference voltage Vref.

A gate electrode of the fourth transistor T4 is electrically connected to the second initial control terminal S5, a source electrode of the fourth transistor T4 is electrically connected to the first node N1, a second electrode of the fourth transistor T4 is electrically connected to the initial voltage terminal I1, and the initial voltage terminal I1 is configured to provide an initial voltage Vint.

A gate electrode of the sixth transistor T6 is electrically connected to the light-emitting control terminal EM, a source electrode of the sixth transistor T6 is electrically connected to a drain electrode of the driving transistor T0, and a drain electrode of the sixth transistor T6 is electrically connected to an anode of the organic light-emitting diode O1. The cathode of the organic light-emitting diode O1 is electrically connected to the low voltage terminal Vss.

In at least one embodiment of the pixel circuit shown in FIG. 20, all transistors are P-type transistors, but not limited thereto.

As shown in FIG. 19, during operation of at least one embodiment of the pixel circuit shown in FIG. 20, the display period may include a reset stage T1, a threshold voltage acquisition stage T2, a signal superposition stage T3, and a light-emitting stage T4 that are successively set;

In the reset stage T1, the EM provides a high voltage signal, S5 provides a low voltage signal, S1 and S4 both provide high voltage signals, and T4 is turned on to write Vint into the first node N1.

In the threshold voltage acquisition stage T2, the EM provides a high voltage signal, S4 provides a low voltage signal, S1 and S5 both provide high voltage signals, T2 and T3 are both turned on to write Vref into the second node N2 and control the connection between the first node N1 and the drain electrode of T3, the potential of N1 is Vd+Vth, Vd is the value of the power supply voltage provided by the power supply voltage Vdd, and Vth is the threshold voltage of T0.

In the signal superposition stage T3, the EM provides a high voltage signal, S1 provides a low voltage signal, S4 and S5 both provide high voltage signals, T1 is turned on, DT provides a data voltage Vdata to the second node N2, and the potential of N1 changes correspondingly.

In the signal superposition stage T3, in the high-brightness mode, the switch control signal provided by the switch control terminal M is controlled such that K0 is turned off, C2 does not participate in the working process of the pixel circuit due to the loop being cut off and single-end being float, and in the signal superposition stage, the voltage variation δVN2 of the second node N2 is coupled to the first node N1 through C1, δVN1 is equal to K2×δVN2, K2 is the second voltage coefficient, K2 is equal to C1z/(C1z+C3z), C1z is the capacitance value of C1, and C3z is the capacitance value of C3; in the low-brightness mode, the switch control signal provided by the switch control terminal M is controlled so that K0 is turned on, the first end of the second capacitor C2 is electrically connected to the first node N1, the second end of the second capacitor C2 is connected with the reference potential terminal FX, and the second capacitor C2 and the third capacitor C3 are connected in parallel to participate in the potential jump voltage-division of the first node N1; δVN1 is equal to K3×δVN2, K3 is a third voltage coefficient, K3 is equal to C1z/(C1z+C2z+C3z), C1z is a capacitance value of C1, C2z is a capacitance value of C2, and C3z is a capacitance value of C3; in the light emitting phase T4, the EM provides a low voltage signal, S1 provides a high voltage signal, S4 and S5 both provide high voltage signals, and T0 drives O1 to emit light.

The pixel circuit according to at least one embodiment of the present disclosure further includes a first initialization circuit, a second initialization circuit, a voltage control circuit, a compensation control circuit and a light-emitting control circuit; the first initialization circuit is electrically connected to an initial control terminal, a reference voltage terminal, and the second node, respectively, and is configured to control the reference voltage terminal to provide a reference voltage to the second node under control of an initial control signal provided by the initial control terminal; the second initialization circuit is electrically connected to the initial control terminal, the initial voltage terminal, and the first node, respectively, and is configured to control the initial voltage terminal to provide an initial voltage to the first node under control of the initial control signal.

The voltage control circuit is electrically connected to the light-emitting control terminal, the reference voltage terminal, and the second node, respectively, and is configured to control the reference voltage terminal to provide a reference voltage to the second node under control of a light-emitting control signal provided by the light-emitting control terminal; the compensation control circuit is electrically connected to the compensation control terminal, the first node, and the second terminal of the driving circuit, respectively, and is configured to control the first node to be connected to or disconnected from the second terminal of the driving circuit under control of the compensation control signal provided by the compensation control terminal; the light-emitting control circuit is electrically connected to the light-emitting control terminal, a second terminal of the driving circuit, and a first electrode of the light-emitting element, and configured to control, under control of the light-emitting control signal, the second terminal of the driving circuit to be connected to or disconnected from the first electrode of the light-emitting element.

A second electrode of the light-emitting element is electrically connected to the second voltage terminal.

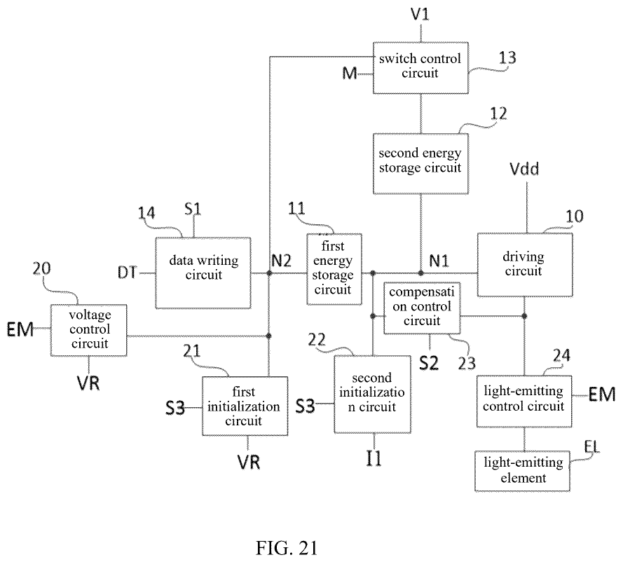

As shown in FIG. 21, on the basis of at least one embodiment of the pixel circuit shown in FIG. 7, the pixel circuit according to at least one embodiment of the present disclosure further includes a first initialization circuit 21, a second initialization circuit 22, a voltage control circuit 20, a compensation control circuit 23, and a light-emitting control circuit 24; the light-emitting element is an organic light-emitting diode O1.

The first initialization circuit 21 is electrically connected to the initial control terminal S3, the reference voltage terminal VR, and the second node N2, respectively, and is configured to control the reference voltage terminal VR to provide the reference voltage Vref to the second node N2 under control of the initial control signal provided by the initial control terminal S3.

The second initialization circuit 22 is electrically connected to the initial control terminal S3, the initial voltage terminal I1, and the first node N1, respectively, and is configured to control the initial voltage terminal I1 to provide an initial voltage to the first node N1 under control of the initial control signal.

The voltage control circuit 20 is electrically connected to the light-emitting control terminal EM, the reference voltage terminal VR, and the second node N2, respectively, and is configured to control the reference voltage terminal VR to provide a reference voltage Vref to the second node N2 under control of a light-emitting control signal provided by the light-emitting control terminal EM.

The compensation control circuit 23 is electrically connected to the compensation control terminal S2, the first node N1, and the second terminal of the driving circuit 10, respectively, and is configured to control the first node N1 to be connected to or disconnected from the second terminal of the driving circuit 10 under control of the compensation control signal provided by the compensation control terminal S2.

The light-emitting control circuit 24 is electrically connected to the light-emitting control terminal EM, a second terminal of the driving circuit 10, and a first electrode of the light-emitting element EL, respectively, and configured to control, under control of the light-emitting control signal, the second terminal of the driving circuit 10 to be connected to or disconnected from the first electrode of the light-emitting element EL.

A second electrode of the light-emitting element EL is electrically connected to the second voltage terminal V2.

Optionally, the compensation control terminal and the write control terminal are the same control terminal; the driving circuit includes a driving transistor, the data writing circuit includes a first transistor, the compensation control circuit includes a second transistor, the first initialization circuit includes a third transistor, the second initialization circuit includes a fourth transistor, the voltage control circuit includes a fifth transistor, the light emitting control circuit includes a sixth transistor, and the light emitting element is an organic light-emitting diode.

A gate electrode of the driving transistor is electrically connected to the first node, and a first electrode of the driving transistor is electrically connected to the power supply voltage terminal; a gate electrode of the first transistor is electrically connected to a write control terminal, a first electrode of the first transistor is electrically connected to a data line, and a second electrode of the first transistor is electrically connected to a second node; a gate electrode of the second transistor is electrically connected to the write control terminal, a first electrode of the second transistor is electrically connected to the first node, and a second electrode of the second transistor is electrically connected to a second electrode of the driving transistor; a gate electrode of the third transistor is electrically connected to the initial control terminal, a first electrode of the third transistor is electrically connected to the second node, and a second electrode of the third transistor is electrically connected to a reference voltage terminal; a gate electrode of the fourth transistor is electrically connected to the initial control terminal, a first electrode of the fourth transistor is electrically connected to the first node, and a second electrode of the fourth transistor is electrically connected to an initial voltage terminal; a gate electrode of the fifth transistor is electrically connected to the light-emitting control terminal, a first electrode of the fifth transistor is electrically connected to the second node, and a second electrode of the fifth transistor is electrically connected to the reference voltage terminal; a gate electrode of the sixth transistor is electrically connected to the light-emitting control terminal, a first electrode of the sixth transistor is electrically connected to a second electrode of the driving transistor, and a second electrode of the sixth transistor is electrically connected to an anode of the organic light-emitting diode;

A cathode of the organic light-emitting diode is electrically connected to the second voltage terminal.

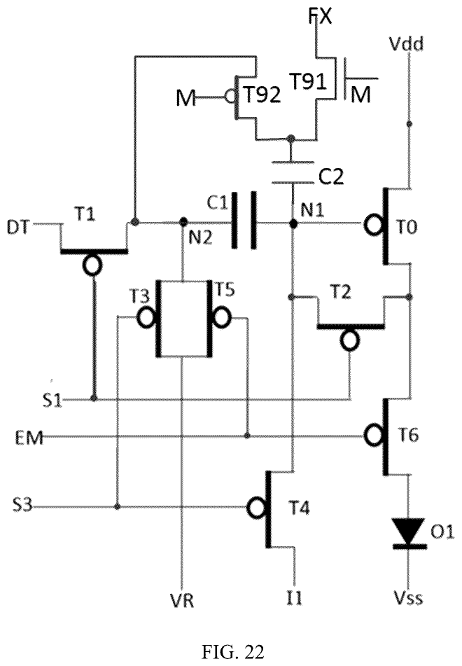

As shown in FIG. 22, on the basis of at least one embodiment of the pixel circuit shown in FIG. 21, the switch control circuit 13 includes a double-throw switch element; the driving circuit includes a driving transistor T0; the data writing circuit includes a first transistor T1, the first energy storage circuit includes a first capacitor C1, and the second energy storage circuit includes a second capacitor C2; a gate electrode of the driving transistor T0 is electrically connected to the first node N1, and a source electrode of the driving transistor T0 is electrically connected to the power supply voltage terminal Vdd; a gate electrode of the first transistor T1 is electrically connected to the write control terminal S1, a source electrode of the first transistor T1 is electrically connected to the data line DT, and a drain electrode of the first transistor T1 is electrically connected to the second node N2; a first end of the first capacitor C1 is electrically connected to the second node N2, and a second end of the first capacitor C1 is electrically connected to the first node N1; a first end of the second capacitor C2 is electrically connected to the first node N1; the double-throw switch element includes a first switch transistor T91 and a second switch transistor T92.

The gate electrode of T91 is electrically connected to the switch control terminal M, the source electrode of T91 is electrically connected to the second end of the second capacitor C2, and the drain electrode of T91 is electrically connected to the reference potential terminal FX; the gate electrode of T92 is electrically connected to the switch control terminal M, the source electrode of T92 is electrically connected to the second end of the second capacitor C2, and the drain electrode of T92 is electrically connected to the second node N2.

The compensation control circuit 23 includes a second transistor T2, the first initialization circuit includes a third transistor T3, the second initialization circuit includes a fourth transistor T4, the voltage control circuit includes a fifth transistor T5, and the light-emitting control circuit includes a sixth transistor T6; the light-emitting element is an organic light-emitting diode O1; a gate electrode of the driving transistor T0 is electrically connected to the first node N1, and a source electrode of the driving transistor T0 is electrically connected to the power supply voltage terminal Vdd.

A gate electrode of the first transistor T1 is electrically connected to the write control terminal S1, a source electrode of the first transistor T1 is electrically connected to the data line DT, and a drain electrode of the first transistor T1 is electrically connected to the second node N2; a gate electrode of the second transistor T2 is electrically connected to the write control terminal S1, a source electrode of the second transistor T2 is electrically connected to the first node N1, and a drain electrode of the second transistor T2 is electrically connected to a drain electrode of the driving transistor T0; a gate electrode of the third transistor T3 is electrically connected to the initial control terminal S3, a source electrode of the third transistor T3 is electrically connected to the second node N2, a drain electrode of the third transistor T3 is electrically connected to a reference voltage terminal VR, and the reference voltage terminal VR is configured to provide a reference voltage Vref.

A gate electrode of the fourth transistor T4 is electrically connected to the initial control terminal S3, a source electrode of the fourth transistor T4 is electrically connected to the first node N1, a drain electrode of the fourth transistor T4 is electrically connected to the initial voltage terminal I1, and the initial voltage terminal I1 is configured to provide an initial voltage Vint.

A gate electrode of the fifth transistor T5 is electrically connected to the light-emitting control terminal EM, a source electrode of the fifth transistor T5 is electrically connected to the second node N2, and a drain electrode of the fifth transistor T5 is electrically connected to the reference voltage terminal VR; a gate electrode of the sixth transistor T6 is electrically connected to the light-emitting control terminal EM, a source electrode of the sixth transistor T6 is electrically connected to a drain electrode of the driving transistor T0, and a drain electrode of the sixth transistor T6 is electrically connected to an anode of the organic light-emitting diode O1; the cathode of the organic light-emitting diode O1 is electrically connected to the low voltage terminal Vss.

In at least one embodiment of the pixel circuit shown in FIG. 22, the write control terminal and the compensation control terminal are the same control terminal.

In at least one embodiment of the pixel circuit shown in FIG. 22, T91 is an N-type transistor, and T92 is a P-type transistor; T0, T1, T2, T3, T4, T5, and T6 are all P-type transistors.

In operation of at least one embodiment of the pixel circuit shown in FIG. 22, in the high brightness mode, the switch control terminal M provides a low voltage signal, T92 is turned on, T91 is turned off, and C1 and C2 are connected in parallel to form a capacitor for signal coupling and holding. In the signal superposition stage, the voltage variation δVN2 of the second node N2 is coupled to the first node N1 through C1, δVN1 is equal to δVN2, the voltage-division ratio of the coupling is N1, then the first node N1 is held by the parallel capacitor formed by C1 and C2 based on the reference potential Vfx, the capacitance capacity is kept to be C1z+C2z, and the potential of the second node N2 needs to be maintained after the potential of the second node N2 jumps.

In the low brightness mode, the switch control terminal M provides a high voltage signal, T91 is turned on, T92 is turned off, the second end of C2 is connected with FX, and the second capacitor C2 participates in the potential jump voltage-division of the first node N1. In the signal superposition stage, δVN1 is equal to K1×δVN2, K1 is the first voltage coefficient, K1 is equal to C1z/(C1z+C2z), the potential of the first node N1 is jointly maintained by the first capacitor C1 based on the potential of the second node N2 and by the second capacitor C2 based on the reference potential Vfx, and the total capacitance capacity maintained is C1z+C2z. in the low brightness mode, the second node N2 may also be float after the potential of the second node N2 jumps, and in this case, the potential of N1 is only maintained by the second capacitor C2 based on the reference potential Vfx, and the holding capacitance is C2z.

In at least one embodiment of the present disclosure, driving of different brightness levels may also be achieved by changing a characteristic of a driving transistor included in the driving circuit, for example, an optional connection to the source electrode or a drain electrode or an optional connection to the gate electrode with different insulating layer thicknesses is led out at different positions of a channel of a driving transistor having a longer channel, and a driving transistor of different gain levels and a driving output of a corresponding controlled transformation are formed by circuit connection selection.

The pixel driving method according to the embodiments of the present disclosure is applied to the pixel circuit, and the pixel driving method includes: the driving circuit drives the light-emitting element under control of the potential of the control terminal of the driving circuit; and the data writing circuit writes the data voltage, provided by the data line, into the second node under control of the write control signal; the first energy storage circuit stores electric energy, and the second energy storage circuit stores electric energy; the switch control circuit controls, under control of the switch control signal, whether the first node is electrically connected to the first voltage terminal through the second energy storage circuit.

Optionally, the step of controlling, by the switch control circuit, whether the first node is connected to the first voltage terminal through the second energy storage circuit under control of the switch control signal includes: in the first display mode, the switch control circuit controls the first node not to be electrically connected to the first voltage terminal through the second energy storage circuit, under control of the switch control signal; in the second display mode, the switch control circuit controls the first node to be electrically connected to the first voltage terminal through the second energy storage circuit, under control of the switch control signal.

In at least one embodiment of the present disclosure, the first display mode may be a highlight display mode, and the second display mode may be a low-brightness display mode.

The display device according to the embodiment of the present disclosure includes the above-mentioned pixel circuit.

The pixel circuit, the pixel driving circuit and the display device according to the embodiments of the present disclosure may perform voltage division transformation on the data voltage by using a capacitor circuit with a controllable voltage division ratio (the capacitor circuit with a controllable voltage division ratio may include a switch control circuit, a first energy storage circuit, and a second energy storage circuit), so as to realize the driving control with a smaller grayscale difference in a low brightness display mode while ensuring driving control with a large brightness dynamic range in a high brightness mode.

The present disclosure is applicable to the field of digital flat panel display, and the display device may be, for example, an AMOLED (Active Matrix Organic light-emitting diode) display device, but is not limited thereto.

The display device provided in the embodiments of the present disclosure may be any product or component having a display function, such as a mobile phone, a tablet computer, a television, a display, a notebook computer, a digital photo frame, a navigator, and the like.

The above are preferred embodiments of the present disclosure, and it should be noted that, for a person of ordinary skill in the art, several improvements and modifications may be made without departing from the principle of the present disclosure, and these improvements and modifications should also be considered as the protection scope of the present disclosure.

1. A pixel circuit, comprising:
a light-emitting element, a driving circuit, a first energy storage circuit, a second energy storage circuit, a switch control circuit, and a data writing circuit;
wherein a control terminal of the driving circuit is electrically connected to a first node, a first terminal of the driving circuit is electrically connected to a power supply voltage terminal, a second terminal of the driving circuit is electrically connected to the light-emitting element, and the driving circuit is configured to drive the light-emitting element under control of a potential at a control terminal of the driving circuit;
the data writing circuit is electrically connected to a write control terminal, a data line, and a second node, respectively, and is configured to write a data voltage, provided by the data line, to the second node under a control of a write control signal provided by the write control terminal;
a first end of the first energy storage circuit is electrically connected to the second node, a second end of the first energy storage circuit is electrically connected to the first node, and the first energy storage circuit is configured to store electric energy;
the switch control circuit is electrically connected to a switch control terminal, the second energy storage circuit, and a first voltage terminal, respectively, and is configured to control, under control of a switch control signal provided by the switch control terminal, whether the first node is electrically connected to the first voltage terminal through the second energy storage circuit; and
the second energy storage circuit is configured to store electric energy.

2. The pixel circuit according to claim 1, wherein a control terminal of the switch control circuit is electrically connected to the switch control terminal, a first terminal of the switch control circuit is electrically connected to the first node, a second terminal of the switch control circuit is electrically connected to a first end of the second energy storage circuit, and the switch control circuit is configured to control, under control of the switch control signal, the first node to be connected to or disconnected from the first end of the second energy storage circuit;
a second end of the second energy storage circuit is electrically connected to the first voltage terminal.

3. The pixel circuit according to claim 1, wherein a first end of the second energy storage circuit is electrically connected to the first node;
a control terminal of the switch control circuit is electrically connected to the switch control terminal, a first terminal of the switch control circuit is electrically connected to a second end of the second energy storage circuit, a second terminal of the switch control circuit is electrically connected to the first voltage terminal, and the switch control circuit is configured to control the second end of the second energy storage circuit to be connected to or disconnected from the first voltage terminal under control of the switch control signal.

4. The pixel circuit according to claim 3, wherein the switch control circuit further comprises a third terminal;
a third terminal of the switch control circuit is electrically connected to the second node, and the switch control circuit is further configured to control, under control of the switch control signal, the second node to be connected to or disconnected from the second end of the second energy storage circuit.

5. The pixel circuit according to claim 2, further comprising:
a third energy storage circuit, wherein a first end of the third energy storage circuit is electrically connected to the first node, a second end of the third energy storage circuit is electrically connected to the first voltage terminal, and the third energy storage circuit is configured to store electric energy.

6. The pixel circuit according to claim 3, further comprising:
a third energy storage circuit, wherein a first end of the third energy storage circuit is electrically connected to the first node, a second end of the third energy storage circuit is electrically connected to the first voltage terminal, and the third energy storage circuit is configured to store electric energy.

7. The pixel circuit according to claim 2, wherein the switch control circuit comprises a switching element, the first energy storage circuit comprises a first capacitor, and the second energy storage circuit comprises a second capacitor;
a control terminal of the switching element is electrically connected to the switch control terminal, a first terminal of the switching element is electrically connected to the first node, and a second end of the second capacitor is electrically connected to a first end of the second capacitor;
and the switching element is configured to control, under control of the switch control signal, the first terminal of the switching element to be connected to or disconnected from the second end of the second capacitor;
a first end of the first capacitor is electrically connected to the second node, and a second end of the first capacitor is electrically connected to the first node;
a second end of the second capacitor is electrically connected to the first voltage terminal.

8. The pixel circuit according to claim 3, wherein the switch control circuit comprises a switching element, the first energy storage circuit comprises a first capacitor, and the second energy storage circuit comprises a second capacitor;
a control terminal of the switching element is electrically connected to the switching control terminal, a first terminal of the switching element is electrically connected to a second end of the second capacitor, and a second terminal of the switching element is electrically connected to the first voltage terminal; and the switching element is configured to control, under control of the switching control signal, the first terminal of the switching element to be connected to or disconnected from the second terminal of the switching element;
a first end of the first capacitor is electrically connected to the second node, and a second end of the first capacitor is electrically connected to the first node;
a first end of the second capacitor is electrically connected to the first node.

9. The pixel circuit according to claim 4, wherein the switch control circuit comprises a double-throw switch element; the first energy storage circuit comprises a first capacitor, and the second energy storage circuit comprises a second capacitor; a first end of the first capacitor is electrically connected to the second node, and a second end of the first capacitor is electrically connected to the first node;
a first end of the second capacitor is electrically connected to the first node;
a control terminal of the double-throw switch element is electrically connected to a switch control terminal, a first terminal of the double-throw switch element is electrically connected to a second end of the second capacitor, a second terminal of the double-throw switch element is electrically connected to the first voltage terminal, and a third terminal of the double-throw switch element is electrically connected to the second node;
the double-throw switch element is configured to control the first terminal of the double-throw switch element to communicate with the second terminal of the double-throw switch element or the third terminal of the double-throw switch element under control of the switch control signal.

10. The pixel circuit according to claim 5, wherein the third energy storage circuit comprises a third capacitor;
a first end of the third capacitor is electrically connected to the first node, and a second end of the third capacitor is electrically connected to the first voltage terminal.

11. The pixel circuit according to claim 1, further comprising:
a first initialization circuit, a second initialization circuit, a voltage control circuit, a compensation control circuit, and a light-emitting control circuit;
wherein the first initialization circuit is electrically connected to an initial control terminal, a reference voltage terminal, and the second node, respectively, and is configured to control the reference voltage terminal to provide a reference voltage to the second node under control of an initial control signal provided by the initial control terminal;
the second initialization circuit is electrically connected to the initial control terminal, the initial voltage terminal, and the first node, respectively, and is configured to control the initial voltage terminal to provide an initial voltage to the first node under control of the initial control signal;
the voltage control circuit is electrically connected to the light-emitting control terminal, the reference voltage terminal, and the second node, and is configured to control the reference voltage terminal to provide a reference voltage to the second node under control of a light-emitting control signal provided by the light-emitting control terminal;
the compensation control circuit is electrically connected to the compensation control terminal, the first node, and a second terminal of the driving circuit, and is configured to control the first node to be connected to or disconnected from the second terminal of the driving circuit under control of a compensation control signal provided by the compensation control terminal;
the light-emitting control circuit is electrically connected to the light-emitting control terminal, a second terminal of the driving circuit, and a first electrode of the light-emitting element, and configured to control, under control of the light-emitting control signal, the second terminal of the driving circuit to be connected to or disconnected from the first electrode of the light-emitting element;
a second electrode of the light-emitting element is electrically connected to the second voltage terminal.

12. The pixel circuit according to claim 11, wherein the compensation control terminal and the write control terminal are the same control terminal; the driving circuit comprises a driving transistor, the data writing circuit comprises a first transistor, the compensation control circuit comprises a second transistor, the first initialization circuit comprises a third transistor, the second initialization circuit comprises a fourth transistor, the voltage control circuit comprises a fifth transistor, the light-emitting control circuit comprises a sixth transistor, and the light-emitting element is an organic light-emitting diode;
a gate electrode of the driving transistor is electrically connected to the first node, and a first electrode of the driving transistor is electrically connected to the power supply voltage terminal;
a gate electrode of the first transistor is electrically connected to the write control terminal, a first electrode of the first transistor is electrically connected to a data line, and a second electrode of the first transistor is electrically connected to a second node;
a gate electrode of the second transistor is electrically connected to the write control terminal, a first electrode of the second transistor is electrically connected to the first node, and a second electrode of the second transistor is electrically connected to a second electrode of the driving transistor;
a gate electrode of the third transistor is electrically connected to the initial control terminal, a first electrode of the third transistor is electrically connected to the second node, and a second electrode of the third transistor is electrically connected to a reference voltage terminal;
a gate electrode of the fourth transistor is electrically connected to the initial control terminal, a first electrode of the fourth transistor is electrically connected to the first node, and a second electrode of the fourth transistor is electrically connected to the initial voltage terminal;
a gate electrode of the fifth transistor is electrically connected to the light-emitting control terminal, a first electrode of the fifth transistor is electrically connected to the second node, and a second electrode of the fifth transistor is electrically connected to the reference voltage terminal;
a gate electrode of the sixth transistor is electrically connected to the light-emitting control terminal, a first electrode of the sixth transistor is electrically connected to a second electrode of the driving transistor, and a second electrode of the sixth transistor is electrically connected to an anode of the organic light-emitting diode;
a cathode of the organic light-emitting diode is electrically connected to a second voltage terminal.

13. The pixel circuit according to claim 5, further comprising:
a first initialization circuit, a second initialization circuit, a compensation control circuit, and a light-emitting control circuit;
wherein the first initialization circuit is electrically connected to a first initial control terminal, a reference voltage terminal, and the second node, and is configured to control the reference voltage terminal to provide a reference voltage to the second node under control of a first initial control signal provided by the first initial control terminal;
the second initialization circuit is electrically connected to the second initial control terminal, the initial voltage terminal, and the first node, and is configured to control the initial voltage terminal to provide an initial voltage to the first node under control of a second initial control signal provided by the second initial control terminal;
the compensation control circuit is electrically connected to the compensation control terminal, the first node, and the second terminal of the driving circuit, and is configured to control the first node to be connected to or disconnected from the second terminal of the driving circuit under control of the compensation control signal provided by the compensation control terminal;
the light-emitting control circuit is electrically connected to a light-emitting control terminal, a second terminal of the driving circuit, and a first electrode of the light-emitting element, and configured to control, under control of the light-emitting control signal, the second terminal of the driving circuit to be connected to or disconnected from the first electrode of the light-emitting element;
a second electrode of the light-emitting element is electrically connected to the second voltage terminal.

14. The pixel circuit according to claim 13, wherein the compensation control terminal and the first initial control terminal are the same control terminal; the driving circuit comprises a driving transistor, the data writing circuit comprises a first transistor, the compensation control circuit comprises a second transistor, the first initialization circuit comprises a third transistor, the second initialization circuit comprises a fourth transistor, and the light-emitting control circuit comprises a sixth transistor; the light-emitting element is an organic light-emitting diode;
a gate electrode of the driving transistor is electrically connected to the first node, and a first electrode of the driving transistor is electrically connected to the power supply voltage terminal;
a gate electrode of the first transistor is electrically connected to the write control terminal, a first electrode of the first transistor is electrically connected to a data line, and a second electrode of the first transistor is electrically connected to a second node;
a gate electrode of the second transistor is electrically connected to the first initial control terminal, a first electrode of the second transistor is electrically connected to the first node, and a second electrode of the second transistor is electrically connected to a second electrode of the driving transistor;
a gate electrode of the third transistor is electrically connected to the first initial control terminal, a first electrode of the third transistor is electrically connected to the second node, and a second electrode of the third transistor is electrically connected to a reference voltage terminal;
a gate electrode of the fourth transistor is electrically connected to the second initial control terminal, a first electrode of the fourth transistor is electrically connected to the first node, and a second electrode of the fourth transistor is electrically connected to an initial voltage terminal;
a gate electrode of the sixth transistor is electrically connected to the light-emitting control terminal, a first electrode of the sixth transistor is electrically connected to a second electrode of the driving transistor, and a second electrode of the sixth transistor is electrically connected to an anode of the organic light-emitting diode;
a cathode of the organic light-emitting diode is electrically connected to a second voltage terminal.

15. A pixel driving method, applied to the pixel circuit according to claim 1, the pixel driving method comprising:
driving, by the driving circuit, the light-emitting element under control of the potential of the control terminal of the driving circuit;
writing the data voltage provided by the data line into the second node under control of a write control signal, by the data writing circuit; wherein, the first energy storage circuit stores electric energy, and the second energy storage circuit stores electric energy;
controlling, by the switch control circuit under control of the switch control signal, whether the first node is electrically connected to the first voltage terminal through the second energy storage circuit.

16. The pixel driving method according to claim 15, wherein the step of controlling, by the switch control circuit, whether the first node is connected to the first voltage terminal through the second energy storage circuit under control of the switch control signal comprises:
in a first display mode, controlling, by the switch control circuit, the first node not to be electrically connected to the first voltage terminal through the second energy storage circuit under control of the switch control signal;
in a second display mode, controlling, by the switch control circuit, the first node to be electrically connected to the first voltage terminal through the second energy storage circuit under control of the switch control signal.

17. A display device, comprising a pixel circuit, wherein the pixel circuit comprises:
a light-emitting element, a driving circuit, a first energy storage circuit, a second energy storage circuit, a switch control circuit, and a data writing circuit;
wherein a control terminal of the driving circuit is electrically connected to a first node, a first terminal of the driving circuit is electrically connected to a power supply voltage terminal, a second terminal of the driving circuit is electrically connected to the light-emitting element, and the driving circuit is configured to drive the light-emitting element under control of a potential at a control terminal of the driving circuit;
the data writing circuit is electrically connected to a write control terminal, a data line, and a second node, respectively, and is configured to write a data voltage, provided by the data line, to the second node under a control of a write control signal provided by the write control terminal;
a first end of the first energy storage circuit is electrically connected to the second node, a second end of the first energy storage circuit is electrically connected to the first node, and the first energy storage circuit is configured to store electric energy;
the switch control circuit is electrically connected to a switch control terminal, the second energy storage circuit, and a first voltage terminal, respectively, and is configured to control, under control of a switch control signal provided by the switch control terminal, whether the first node is electrically connected to the first voltage terminal through the second energy storage circuit; and
the second energy storage circuit is configured to store electric energy.
